(19) United States
(12) Patent Application Publication
(10) Pub. No.: US 2026/0099873 A1
(43) Pub. Date: Apr. 9, 2026

(54) RECOMMENDATION METHOD, ELECTRONIC DEVICE AND COMPUTER-READABLE MEDIUM

(71) Applicant: BEIJING ZITIAO NETWORK TECHNOLOGY CO., LTD, Beijing (CN)

(72) Inventors: Yanjun JIAN, Beijing (CN); Wenjun WANG, Beijing (CN); Juan WANG, Beijing (CN); Hanfei WU, Beijing (CN); Chen CHEN, Beijing (CN); Chaoxiang HAN, Beijing (CN); Changlei PAN, Beijing (CN); Lian WU, Beijing (CN); Fuxing HONG, Beijing (CN); Bingjie HU, Beijing (CN); Chuang WANG, Beijing (CN); Yuhang ZHANG, Beijing (CN); Xiang LIU, Beijing (CN); Qianwen LI, Beijing (CN); Shi KUANG, Beijing (CN)

(21) Appl. No.: 19/113,875

(22) PCT Filed: Sep. 19, 2023
(86) PCT No.: PCT/CN2023/119648

§ 371 Date: Mar. 20, 2025

(30) Foreign Application Priority Data
Sep. 20, 2022 (CN) 202211146537.X

(51) Int. Cl. G06Q 30/0601; G06F 3/04842

(52) U.S. Cl. CPC G06Q 30/0631; G06F 3/04842; G06Q 30/0641

(57) ABSTRACT

A recommendation method, an electronic device and a computer-readable medium are provided. The recommendation method, applied to a first client, includes: in response to a first operation, displaying an information configuration page; in response to a trigger operation on a first control in the information configuration page, displaying an object aggregation page, where the object aggregation page includes recommendation description information of at least one candidate object corresponding to a target account; in response to a selection operation on recommendation description information of at least one target object in the at least one candidate object, updating the information configuration page by using the recommendation description information of the at least one target object; and in response to a trigger operation on a second control in the information configuration page, generating an object recommendation interface corresponding to the information configuration page.

The present application claims priority of the Chinese Patent Application No. 202211146537.X, filed on Sep. 20, 2022, entitled “RECOMMENDATION METHOD AND APPARATUS, AND ELECTRONIC DEVICE AND COMPUTER-READABLE MEDIUM”, the disclosure of which is incorporated herein by reference in its entirety.

### TECHNICAL FIELD

The present disclosure relates to the field of Internet technology, in particular to a recommendation method and apparatus, an electronic device and a computer-readable medium.

### BACKGROUND

With the development of internet technology, internet is used to implement certain interactive processes for a specific product. The product recommendation refers to using the internet to recommend a product offered by a specific merchant to other users.

However, due to defects of some recommendation approaches, the recommendation approaches have relatively low efficiency and cannot meet the need of users, thereby resulting in poor user experience.

### SUMMARY

The present disclosure provides a recommendation method and apparatus, an electronic device and a computer-readable medium.

In order to implement the above purpose, the technical solutions provided by the present disclosure are shown as following.

The present disclosure provides a recommendation method, and the method is applied to the first client. The method includes: in response to a first operation, displaying an information configuration page; in response to a trigger operation on a first control in the information configuration page, displaying an object aggregation page, in which the object aggregation page includes recommendation description information of at least one candidate object corresponding to a target account; in response to a selection operation on recommendation description information of at least one target object in the at least one candidate object, updating the information configuration page by using the recommendation description information of the at least one target object; and in response to a trigger operation on a second control in the information configuration page, generating an object recommendation interface corresponding to the information configuration page, in which the object recommendation interface is used for displaying the recommendation description information of the at least one target object.

In a possible implementation mode, the information configuration page includes an information configuration area and a preview area; and the updating the information configuration page by using the recommendation description information of the at least one target object, includes: adding the recommendation description information of the at least one target object in the information configuration area, and updating an interface to be used that is displayed in the preview area by using the recommendation description information of the at least one target object.

In a possible implementation mode, before the in response to a first operation, displaying an information configuration page, the method further includes: displaying an information management page, in which the information management page includes interface description information of at least one first recommendation interface corresponding to the target account; the in response to a first operation, displaying an information configuration page, includes: in response to a trigger operation on a third control in the information management page, switching from the information management page to the information configuration page; and the in response to a trigger operation on a second control in the information configuration page, generating an object recommendation interface corresponding to the information configuration page, includes: in response to the trigger operation on the second control in the information configuration page, generating the object recommendation interface corresponding to the information configuration page, switching from the information configuration page to the information management page, and updating the information management page by using interface description information of the object recommendation interface, in which the updated information management page includes the interface description information of the object recommendation interface and the interface description information of the at least one first recommendation interface.

In a possible implementation mode, the updated information management page further includes a first candidate control corresponding to the object recommendation interface; the method further includes: when the first candidate control corresponding to the object recommendation interface is in a first display state, in response to a trigger operation on the first candidate control, adjusting state description information in the interface description information of the object recommendation interface to first state description information, and/or, sending an interface display end request corresponding to the object recommendation interface to a second client, in which a preset association relationship exists between an account corresponding to the second client and the target account, and the interface display end request is used for requesting to end a recommendation-display process for the object recommendation interface; or the method further includes: when a publishing duration of the object recommendation interface is determined to meet a duration threshold corresponding to the object recommendation interface, adjusting the state description information in the interface description information of the object recommendation interface to the first state description information, and/or, sending the interface display end request corresponding to the object recommendation interface to the second client.

In a possible implementation mode, the updated information management page further includes a second candidate control corresponding to the object recommendation interface; and the method further includes: when the second candidate control corresponding to the object recommendation interface is in a second display state, in response to a trigger operation on the second candidate control, switching from the information management page to an information configuration page corresponding to the object recommendation interface.

In a possible implementation mode, the updated information management page further includes a third candidate control corresponding to the object recommendation interface; and the method further includes: in response to a trigger operation on the third candidate control, displaying an interface description page corresponding to the object recommendation interface on the information management page, in which the interface description page is used for displaying the object recommendation interface and the interface description information of the object recommendation interface.

In a possible implementation mode, after the displaying an interface description page corresponding to the object recommendation interface on the information management page, the method further includes: when a fourth control in the interface description page is in a third display state, in response to a trigger operation on the fourth control, jumping to an information configuration page corresponding to the object recommendation interface.

In a possible implementation mode, when state description information in the interface description information of the object recommendation interface is second state description information, the interface description page is further used for displaying prompt information corresponding to the second state description information.

In a possible implementation mode, In a possible implementation mode, when the information management page is displayed and the information management page includes at least one second recommendation interface, in response to a condition input operation triggered on an information filtering condition input area in the information management page, displaying interface description information of a target recommendation interface in the at least one second recommendation interface on the information management page, in which the interface description information of the target recommendation interface meets an information filtering condition corresponding to the condition input operation, the at least one second recommendation interface includes the at least one first recommendation interface, or the at least one second recommendation interface includes the at least one first recommendation interface and the object recommendation interface.

In a possible implementation mode, the method further includes: when the information management page is displayed and the information management page includes at least one second recommendation interface, in response to an account switching operation triggered on an account input area in the information management page, on the information management page, switching from interface description information of the at least one second recommendation interface corresponding to the target account to interface description information of at least one third recommendation interface corresponding to an account to be used, in which the account switching operation is used for switching from the target account to the account to be used in the account input area, the at least one second recommendation interface includes the at least one first recommendation interface, or the at least one second recommendation interface includes the at least one first recommendation interface and the object recommendation interface.

In a possible implementation mode, after the displaying an information configuration page, the method further includes: in response to a trigger operation on a fifth control in the information configuration page, displaying a template configuration page; and in response to a template updating operation on the template configuration page, updating the information configuration page by using a recommendation interface template corresponding to the template updating operation, in which the updated information configuration page is used for displaying at least one information configuration item in the recommendation interface template.

The present disclosure further provides a recommendation apparatus, which includes a first display unit, a second display unit, a first updating unit and an interface generating unit. The first display unit is configured to, in response to a first operation, display an information configuration page. The second display unit is configured to, in response to a trigger operation on a first control in the information configuration page, display an object aggregation page, in which the object aggregation page includes recommendation description information of at least one candidate object corresponding to a target account. The first updating unit is configured to, in response to a selection operation on recommendation description information of at least one target object in the at least one candidate object, update the information configuration page by using the recommendation description information of the at least one target object. The interface generating unit is configured to, in response to a trigger operation on a second control in the information configuration page, generate an object recommendation interface corresponding to the information configuration page, in which the object recommendation interface is used for displaying the recommendation description information of the at least one target object.

The present disclosure further provides an electronic device. The device includes a processor and a memory. The memory is configured to store instructions or computer programs; and the processor is configured to execute the instructions or computer programs in the memory to cause the electronic device to execute the recommendation method provided by the present disclosure.

The present disclosure further provides a computer-readable medium. The computer-readable medium stores instructions or computer programs, and when the instructions or computer programs are run on a device, the device is caused to execute the recommendation method provided by the present disclosure.

The present disclosure provides a computer program product, which includes a computer program carried on a non-transitory computer-readable medium. The computer program includes a program code used for executing the recommendation method provided by the present disclosure.

### BRIEF DESCRIPTION OF DRAWINGS

In order to more clearly illustrate the technical solutions in the embodiments of the present disclosure or related art, the drawings required to be used in the embodiments or related technical descriptions will be briefly introduced below, and it is obvious that the drawings in the following description are only some embodiments recorded in the present disclosure, and other drawings can be obtained according to those drawings for those skilled in the art without creative work.

FIG. 1 is a flowchart of a recommendation method provided by an embodiment of the present disclosure;

FIG. 2 is a schematic diagram of an information configuration page provided by an embodiment of the present disclosure;

FIG. 3 is a schematic diagram of an information configuration page provided by an embodiment of the present disclosure;

FIG. 4 is a schematic diagram of an information configuration page provided by an embodiment of the present disclosure;

FIG. 5 is a schematic diagram of an object recommendation interface provided by an embodiment of the present disclosure;

FIG. 6 is a schematic diagram of an information management page provided by an embodiment of the present disclosure;

FIG. 7 is a schematic diagram of an information management page provided by an embodiment of the present disclosure;

FIG. 8 is a schematic diagram of an information management page provided by an embodiment of the present disclosure;

FIG. 9 is a schematic diagram of an information management page provided by an embodiment of the present disclosure;

FIG. 10 is a schematic diagram of an information management page provided by an embodiment of the present disclosure;

FIG. 11 is a schematic diagram of an interface description page provided by an embodiment of the present disclosure;

FIG. 12 is a schematic diagram of an interface description page provided by an embodiment of the present disclosure;

FIG. 13 is a schematic diagram of an information management page provided by an embodiment of the present disclosure;

FIG. 14 is a schematic diagram of a resource display page corresponding to a preset tag provided by an embodiment of the present disclosure;

FIG. 15 is a flowchart of another recommendation method provided by an embodiment of the present disclosure;

FIG. 16 is a schematic diagram of an unsubscribing process of a recommendation information aggregation card provided by an embodiment of the present disclosure;

FIG. 17 is a schematic diagram of an unsubscribing process of a recommendation information aggregation card provided by an embodiment of the present disclosure;

FIG. 18 is a schematic diagram of an unsubscribing process of a recommendation information aggregation card provided by an embodiment of the present disclosure;

FIG. 19 is a schematic diagram of an unsubscribing process of a recommendation information aggregation card provided by an embodiment of the present disclosure;

FIG. 20 is a schematic diagram of an unsubscribing process of a recommendation information aggregation card provided by an embodiment of the present disclosure;

FIG. 21 is a schematic diagram of a sharing process of a recommendation information aggregation card provided by an embodiment of the present disclosure;

FIG. 22 is a structural schematic diagram of a recommendation apparatus provided by an embodiment of the present disclosure; and

FIG. 23 is a structural schematic diagram of an electronic device provided by an embodiment of the present disclosure.

### DETAILED DESCRIPTION

To solve the technical problems mentioned in the background part, an embodiment of the present disclosure provide a recommendation method. The method includes the following steps: for the first client (e.g., a client for providing a store management service for a certain merchant), after the first client receives a first operation, displaying an information configuration page, so that a user of the first client can use the information configuration page to configure some recommendation information aggregation cards that meet the user's personalized needs (e.g., a product aggregation card that focuses on recommending multiple products with promotional activities, etc.), so after the first client receives a trigger operation on a first control (e.g., a control for selecting at least one product, etc.) in the information configuration page, displaying an object aggregation page, and the object aggregation page being used for displaying recommendation description information of at least one candidate object corresponding to a target account, so that after the first client receives a selection operation on the recommendation description information of at least one target object among these candidate objects, updating the information configuration page by using the recommendation description information of these target objects, which allows the information configuration page to include the recommendation description information of the target objects; finally, after the first client receives a trigger operation on a second control (e.g., submission control) in the information configuration page, generating an object recommendation interface corresponding to the information configuration page, and the object recommendation interface being used for displaying the recommendation description information of these target objects, so that when the object recommendation interface is shown to a user, the user can view the recommendation description information of these target objects from the object recommendation interface, which can better meet the personalized product recommendation requirements of some merchants, thereby helping to improve the product recommendation experience of these merchants.

In addition, for the above information configuration page, the user of the first client only needs to execute some simple operations on the information configuration page, such as character input operation (e.g., inputting title content, etc.) and information selection operation (e.g., selecting the recommendation description information of some objects, etc.), without the need for executing other complicated operations (e.g., video data production, etc.). This can effectively simplify the production process of the above object recommendation interface, thereby helping to improve the user's interface production experience.

In addition, the embodiment of the present disclosure do not limit the execution subject of the recommended method provided by the embodiment of the present disclosure, for example, the recommended method provided by the embodiment of the present disclosure may be applied to a terminal device or a server. For another example, the recommendation method provided by the embodiment of the present disclosure can also be implemented through a data exchange process between a terminal device and a server. The terminal device may be a smartphone, a computer, a personal digital assistant (PDA), a tablet, etc. The server may be standalone server, a clustered server, or a cloud server.

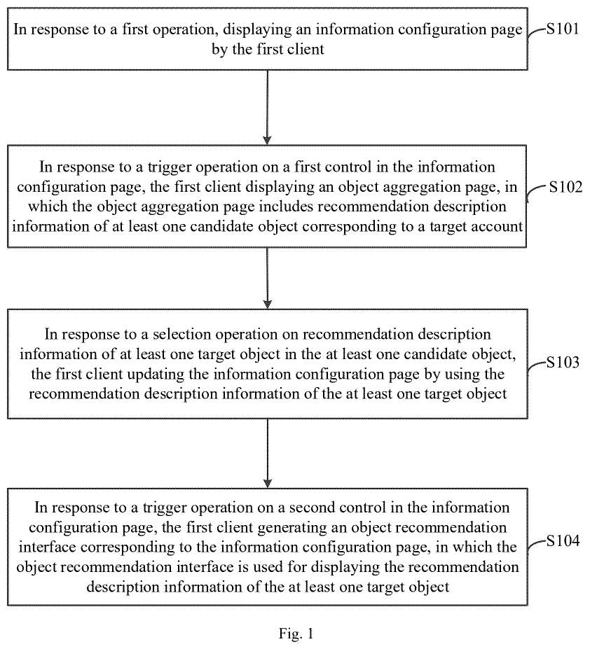

To better understand the technical scheme of the present disclosure, the recommendation method provided by the present disclosure will be described below with reference to some accompanying drawings. As shown in FIG. 1, the recommendation method applied to the first client provided by the embodiment of the present disclosure includes S101-S104 below. FIG. 1 is a flowchart of a recommendation method provided by an embodiment of the present disclosure.

S101: in response to a first operation, displaying an information configuration page by the first client.

The first client is used for providing some management services (e.g., store management, product management, the process of creating and publishing recommendation information aggregation cards, the management process for created recommendation information aggregation cards, etc.) for the user of the first client. The recommendation information aggregation card is used for recommending and displaying recommendation description information of some objects (e.g., some created product information cards). The product information card is used for displaying recommendation description information of a product (e.g., the information such as product name, product price, and product discount). The recommendation description information is used for describing the related content of the product (e.g., information such as product name and product price for introducing the product, and information such as product discount for indicating the reason for recommending the product).

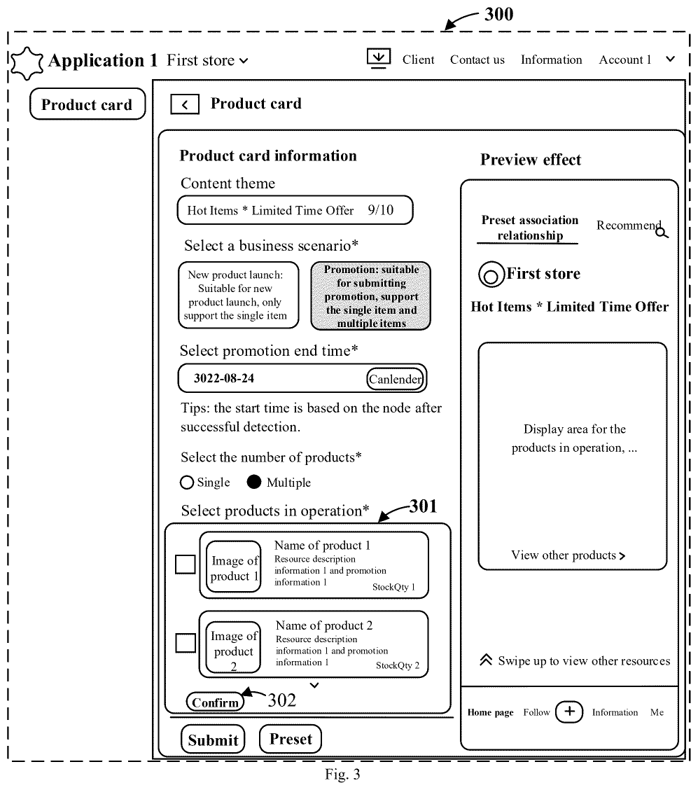

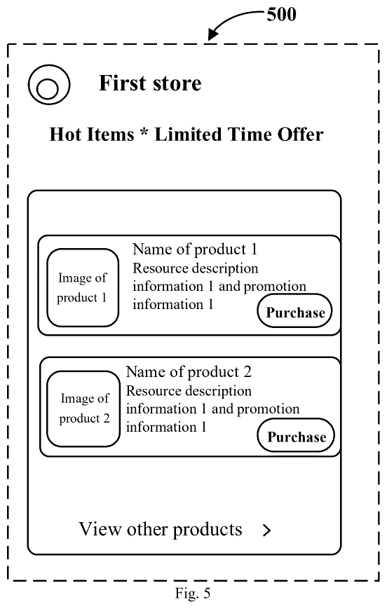

It should be noted that the above recommendation information aggregation card is not limited by the embodiment of the present disclosure. For example, the recommendation information aggregation card may be similar to an object recommendation interface shown in FIG. 5 below, so that the recommendation information aggregation card can aggregate and display the product information cards of multiple products. In addition, the product information card is not limited by the embodiment of the present disclosure, for example, it may be implemented by any related or future information card that can display product information. As another example, the product information card may refer to a product information card shown in area 301 in FIG. 3 below. In addition, the above recommendation description information is not limited by the embodiment of the present disclosure, for example, the recommendation description information may include some information shown for product 1 in area 301 in FIG. 3.

In addition, the first client is not limited by the embodiment of the present disclosure, for example, the first client may refer to a client of an application 1 shown in FIG. 1, so that the user of the first client can use the application 1 on the first client. Here, the application 1 is used for providing some management services (e.g., store management, product management, the process of creating and publishing recommendation information aggregation cards, the management process for created recommendation information aggregation cards, etc.) for the user of the application 1. Moreover, the implementation mode of the application 1 is not limited by the embodiment of the present disclosure. For example, the application 1 may be used for information management (e.g., product recommendation information management, product management, store management, etc.) for some user accounts in an application 2 (in particular, user accounts corresponding to some stores). The application 2 is used for providing some resource display services (e.g., short video data display service, live video display service, merchant detail page display service, etc.) to the user of the application 2.

The first operation is used for triggering a recommendation information aggregation configuration process for some objects (e.g., products, etc.). Moreover, the first operation is not limited by the embodiment of the present disclosure, for example, the first operation may be preset according to the application scenario. As another example, the first operation may be implemented by means of an operation for triggering a display process of an information configuration page shown in steps 11-12 below.

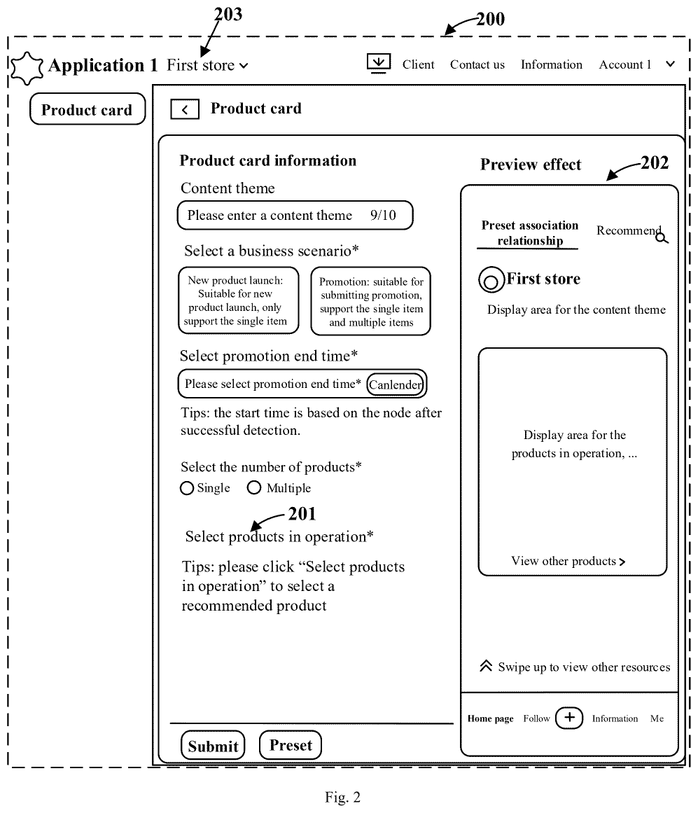

The information configuration page is used for providing some recommendation information aggregation configuration functions. Moreover, the information configuration page is not limited by the embodiment of the present disclosure, for example, the information configuration page may be a page 200 shown in FIG. 2.

In a possible implementation mode, the above information configuration page may include an information configuration area (e.g., an area shown in FIG. 2 for configuring product card information). The information configuration area is used for providing an information configuration function to the user of the first client. Moreover, the information configuration area is not limited by the embodiment of the present disclosure, for example, the information configuration area may include at least one selected from the group consisting of a first configuration area, a second configuration area, a third configuration area, a fourth configuration area, a fifth configuration area and a sixth configuration area.

The above “first configuration area” is used for configuring a recommendation display account of a recommendation information aggregation card (e.g., the “first store” account shown in area 203 of FIG. 2), so that the recommendation information aggregation card can finally be published and displayed according to the recommendation display account. The recommendation display account is used for displaying the recommendation information aggregation card to other users (in particular, users who have a preset association relationship with the recommendation display account in application 2), so that these users can view the recommendation information aggregation card from a second client they use.

In addition, the above recommendation display account is not limited by the embodiment of the present disclosure. For example, when the above first client is a client of the application 1, and the user of the first client can provide some displayable resource information (e.g., recommendation information aggregation card, etc.) to the application 2 by using the application 1, the recommendation display account may refer to a user account created and used under the application 2 (e.g., the “first store” account shown in area 203 of FIG. 2), so that the user of the first client can use the recommendation display account on the first client to configure some resource information (e.g., recommendation information aggregation card, etc.) that can be displayed in the application 2.

In addition, the implementation mode of the above “first configuration area” is not limited by the embodiment of the present disclosure, for example, the first configuration area may be implemented by using the area 203 shown in FIG. 2.

The above “second configuration area” is used for configuring a recommendation theme of a recommendation information aggregation card, so that the recommendation theme can indicate the content theme of the content displayed in the recommendation information aggregation card (e.g., the content theme of “Hot Items*Limited Time Offer” shown in FIG. 3). Here, the recommendation theme is used for describing the content theme of the content displayed in the recommendation information aggregation card.

In addition, the implementation mode of the above “second configuration area” is not limited by the embodiment of the present disclosure, for example, the second configuration area may be implemented by using the area for configuring the content theme shown in FIG. 2.

The above “third configuration area” is used for configuring recommendation scenario description information of a recommendation information aggregation card, so that the recommendation scenario description information can indicate the business scenario (e.g., the new product launch or promotion scenario shown in FIG. 2) to which the objects (e.g., products) displayed in the recommendation information aggregation card belong. Here, the recommendation scenario description information is used for describing the business scenario to which the objects (e.g., products) displayed in the recommendation information aggregation card belong.

In addition, the implementation mode of the above “third configuration area” is not limited by the embodiment of the present disclosure, for example, the third configuration area may be implemented by using the area for selecting a business scenario shown in FIG. 2.

The above “fourth configuration area” is used for configuring timeliness information of a recommendation information aggregation card, so that the timeliness information can indicate the time period during which the recommendation information aggregation card can be recommended and displayed by the second client below. The timeliness information is used for describing the time period (e.g., from Jul. 1, 2022 to Aug. 24, 2022) during which the recommendation information aggregation card can be recommended and displayed by the second client below.

In addition, the implementation mode of the above “fourth configuration area” is not limited by the embodiment of the present disclosure, for example, the fourth configuration area may be implemented by using the area for selecting a promotion end time shown in FIG. 2.

The above “fifth configuration area” is used for configuring recommended object number description information of a recommendation information aggregation card, so that the recommended object number description information can indicate how many objects'related information is aggregated and displayed in the recommendation information aggregation card (e.g., how many products'product information cards are aggregated and displayed). Here, the recommended object number description information is used for describing how many objects'related information is aggregated and displayed in the recommendation information aggregation card (e.g., how many products'product information cards are aggregated and displayed).

In addition, the implementation mode of the above “fifth configuration area” is not limited by the embodiment of the present disclosure, for example, the fifth configuration area may be implemented by using the area for selecting the number of products shown in FIG. 2, so that the above recommended object number description information can be a string “single item”or a string “multiple items”.

The above “sixth configuration area” is used for selecting recommendation description information of a recommended object in a recommendation information aggregation card (e.g., the related information of product 1 and the related information of product 2 in FIG. 3). Here, the recommendation description information is used for describing the related content of the recommended object. Moreover, the recommendation description information is not limited by the embodiment of the present disclosure, for example, the recommendation description information may be implemented by means of an information card (e.g., a product information card displayed in area 301 of FIG. 3). It can be seen that the user of the first client can directly select one or more product cards from a plurality of product cards (e.g., all product cards shown in page 301 of FIG. 3) as the recommendation description information of the recommended object by means of the sixth configuration area, so that a recommendation information aggregation card can be created later based on these selected product cards.

In addition, the implementation mode of the above “sixth configuration area” is not limited by the embodiment of the present disclosure, for example, the sixth configuration area may be implemented by using the area for selecting products to operate shown in FIG. 2.

In addition, to improve the configuration effect of the recommendation information better, an embodiment of the present disclosure also provides another possible implementation mode of the above information configuration page. In this implementation mode, the information configuration page includes not only an information configuration area, but also a preview area (e.g., the area 202 in FIG. 2), so that the content displayed in the preview area will change in real time with the configuration operation in the information configuration area. This ensures that the user of the first client can timely view the impact of the triggered configuration operation on the recommendation information aggregation card in the preview area, thereby allowing the user to easily know what the recommendation information aggregation card they have configured looks like from within the preview area.

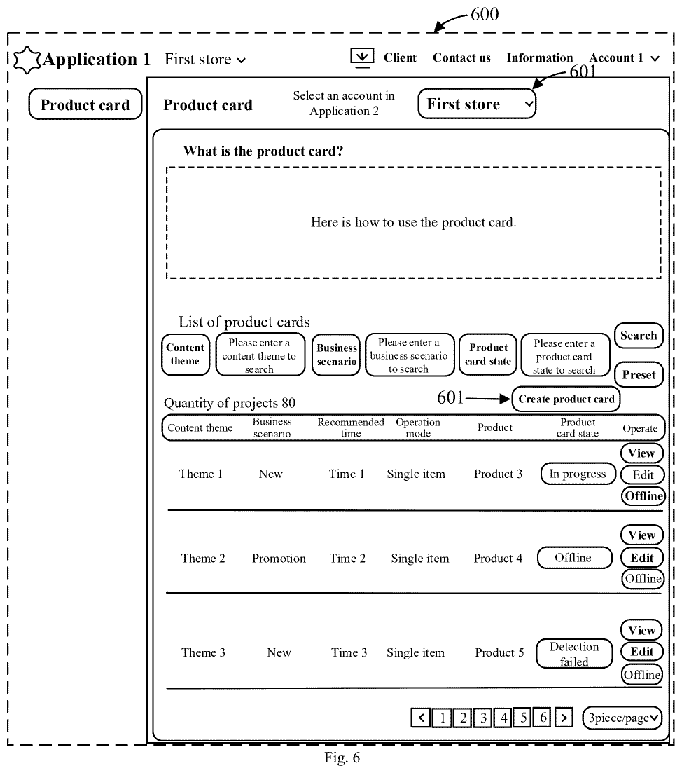

Based on the related content of S101, it can be known that for the first client used by a merchant, after the first client receives the first operation triggered by the merchant (e.g., as shown in FIG. 2, the operations of opening application→clicking on marketing management→clicking on associated users'product card→clicking on a control 601 in FIG. 6 below), the information configuration page may be displayed to the merchant, so that the merchant can use the information configuration page to configure a recommendation information aggregation card that meets the personalized product recommendation requirements, which can subsequently recommend and display the recommendation information aggregation card to the associated users of the merchant. This can satisfy the merchant's personalized product recommendation requirements and thereby improve the user experience. The associated users refer to the users who have a preset association relationship with an account corresponding to the merchant (e.g., the “first store” account).

S102: in response to a trigger operation on a first control in the information configuration page, the first client displaying an object aggregation page, in which the object aggregation page includes recommendation description information of at least one candidate object corresponding to a target account.

Here, the first control is used for triggering a selection process for the recommendation description information of some objects (e.g., product information cards of some products). Moreover, the first control is not limited by the embodiment of the present disclosure, for example, the first control may be a control 201 shown in FIG. 2.

In addition, the above “trigger operation on a first control in the information configuration page” is not limited by the embodiment of the present disclosure, for example, the trigger operation may be a click operation.

The above “target account” refers to an account selected by the user of the first client on the above information configuration page (particularly, a user account that has been created under application 2), so that the target account (e.g., the “first store” account shown in area 203 of FIG. 2) can indicate which user account the user of the first client is configuring the recommendation information aggregation for.

The above “candidate objects” refer to interactive (e.g., collectable, viewable, interactable) objects (e.g., some products) provided by the above target account, so that other users can perform some interactive operations (e.g., collecting, viewing, interacting operations) on these candidate objects on some pages (e.g., store detail page) corresponding to the target account. For example, when the above target account is a user account created and used under application 2 for a specific store, the candidate objects may be the products provided by the store that are interactive (e.g., collectable, viewable, interactable).

The above “recommendation description information of a candidate object” is used for recommending and introducing the candidate object. Moreover, the “recommendation description information of a candidate object” is not limited by the embodiment of the present disclosure, for example, it may include some relevant information of the candidate object. In addition, the display mode of the “recommendation description information of a candidate object” is not limited by the embodiment of the present disclosure, for example, it may be displayed by means of a product information card (e.g., the product information card of product 1 shown in FIG. 3). It should be noted that the product information card may be pre-configured by the user of the first client in a “product management”module shown in FIG. 3.

The above “object aggregation page” is used for aggregating and displaying the recommendation description information of at least one candidate object corresponding to the above target account. Moreover, the object aggregation page is not limited by the embodiment of the present disclosure. For example, when the above target account is the “first store” account shown in FIG. 3, the object aggregation page may be page 301 in FIG. 3, so that the object aggregation page can aggregate and display the recommendation description information of all objects under the first store (e.g., the product information cards of all products).

In addition, the display mode of the above “object aggregation page” is not limited by the embodiment of the present disclosure, for example, it may be implemented by any related or future page display mode. For another example, specifically, the object aggregation page is displayed on the above information configuration page, so that the selection process for the recommendation description information of some objects can be implemented without leaving the information configuration page, which helps to improve the user experience.

Based on the related content of S102 mentioned above, it can be known that for the first client used by a certain merchant, when the first client is displaying the information configuration page (e.g., page 200 shown in FIG. 2) and the above target account (e.g., the “first store” account shown in area 203 in FIG. 2) has been selected on the information configuration page, after the first client receives the trigger operation on the first control (e.g., the control 201 in FIG. 2) in the information configuration page, the object aggregation page (e.g., page 301 in FIG. 3) is displayed on the information configuration page, so that the object aggregation page can aggregate and display the recommendation description information of at least one candidate object corresponding to the target account (e.g., the product information card of product 1 and the product information card of product 2 shown in FIG. 3), allowing the user of the first client to select recommendation description information of one or more candidate objects from the object aggregation page based on their personalized recommendation needs, thereby better satisfying the user's personalized product recommendation requirements and improving the user experience.

S103: in response to a selection operation on recommendation description information of at least one target object in the at least one candidate object, the first client updating the information configuration page by using the recommendation description information of the at least one target object.

The target object refers to an object described by the recommendation description information selected in the above object aggregation page. For example, when the object aggregation page is page 301 in FIG. 3, in response to a viewer of the object aggregation page triggering a selection operation on the product information card of product 1 shown in FIG. 3, the target object is the product 1, and the recommendation description information of the target object is the product information card of the product 1.

The above “recommendation description information of target object” is used for recommending and introducing the target object. Moreover, the “recommendation description information of target object” is similar to the above “recommendation description information of a candidate object”, which is not repeated here for brevity.

In addition, the above “selection operation on recommendation description information of at least one target object in the at least one candidate object” is not limited by the embodiment of the present disclosure, for example, it may be implemented by any related or future information selection operation. For another example, as shown in FIG. 3, it may specifically include a selection operation (e.g., a click operation or a check operation) on the recommendation description information of at least one target object and a trigger operation (e.g., a click operation) on the control 302.

In addition, the above “selection operation on recommendation description information of at least one target object in the at least one candidate object”may be preset according to the application scenario.

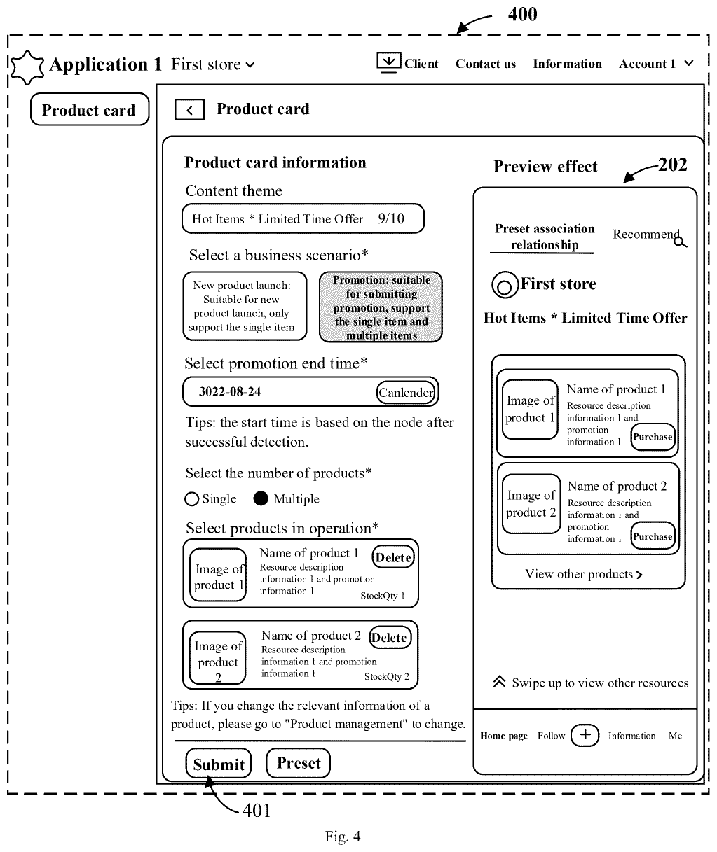

Furthermore, the implementation mode of the above step “updating the information configuration page by using the recommendation description information of the at least one target object” in S103 is not limited by the embodiment of the present disclosure. For example, when the information configuration page includes an information configuration area and a preview area, it may specifically include: adding the recommendation description information of the at least one target object in the information configuration area (e.g., the sixth configuration area above), and updating an interface to be used that is displayed in the preview area by using the recommendation description information of the at least one target object, so that the recommendation description information of the at least one target object is displayed on the updated interface to be used (e.g., an interface shown in area 402 in FIG. 4). The interface to be used refers to the content displayed in the preview area, so that the interface to be used can simulate a display effect of a recommendation information aggregation card being created.

In addition, to prevent the above object aggregation page from affecting the user's viewing experience of the update effect of the above information configuration page, an embodiment of the present disclosure also provides a possible implementation mode of S103 above. In the implementation mode, when the above “selection operation on recommendation description information of at least one target object in the at least one candidate object” includes a selection operation on the recommendation description information of these target objects (e.g., clicking on the product card of product 1 in FIG. 3) and a trigger operation on a fifth control (e.g., the control 302 shown in FIG. 3) in the object aggregation page, S103 may specifically include: after the first client receives the trigger operation on the fifth control (e.g., the control 302 shown in FIG. 3) in the object aggregation page, closing the object aggregation page and updating the information configuration page by using the recommendation description information of the at least one target object, so that the object aggregation page does not exist in the updated information configuration page (e.g., page 400 shown in FIG. 4), which effectively prevents the object aggregation page from obstructing the information on the information configuration page.

Based on the related content of S103, it can be known that for the first client used by a merchant, when the first client is displaying the information configuration page (e.g., page 300 shown in FIG. 3) and the object aggregation page (e.g., page 301 shown in FIG. 3) is displayed on the information configuration page, after the first client receives the selection operation on the recommendation description information of the at least one target object in the object aggregation page, the recommendation description information of these target objects can be directly used to update the information configuration page, so that the recommendation description information of these target objects is added to the updated information configuration page (e.g., page 400 shown in FIG. 4), thus implementing the purpose of the user of the first client using the object aggregation page to select the objects that meet their personalized recommendation requirements, which helps to improve the user experience.

S104: in response to a trigger operation on a second control in the information configuration page, the first client generating an object recommendation interface corresponding to the information configuration page, in which the object recommendation interface is used for displaying the recommendation description information of the at least one target object.

Here, the second control is used for triggering a submission process of the recommendation information aggregation card configured by the above information configuration page. Moreover, the second control is not limited by the embodiment of the present disclosure. For example, when the information configuration page is the page 400 shown in FIG. 4, the second control may specifically be the control 401 shown in FIG. 4.

In addition, the above “trigger operation on a second control in the information configuration page” is not limited by the embodiment of the present disclosure, for example, it may be a click operation.

The above “object recommendation interface corresponding to the information configuration page” is used for recommending information according to relevant information (such as content title and business scenario) configured on the information configuration page. Moreover, the “object recommendation interface corresponding to the information configuration page” is not limited by the embodiment of the present disclosure. For example, the “object recommendation interface corresponding to the information configuration page” (e.g., interface 500 shown in FIG. 5) is consistent with an interface shown in the preview area (e.g., area 402 shown in FIG. 4) of the information configuration page.

In addition, the implementation mode of the above “object recommendation interface corresponding to the information configuration page” is not limited by the embodiment of the present disclosure, for example, it may be implemented by means of a card (e.g., a recommendation information aggregation card shown in FIG. 5). It can be seen that the “object recommendation interface corresponding to the information configuration page” may refer to a recommendation information aggregation card newly created by the user of the first client for the above target account.

Based on the related content of S101 to S104, it can be known that the method includes: for the first client (e.g., a client for providing a store management service for a certain merchant), after the first client receives a first operation, displaying an information configuration page, so that a user of the first client can use the information configuration page to configure some recommendation information aggregation cards that meet the user's personalized needs (e.g., a product aggregation card that focuses on recommending multiple products with promotional activities, etc.), so after the first client receives a trigger operation on a first control (e.g., a control for selecting at least one product, etc.) in the information configuration page, displaying an object aggregation page, and the object aggregation page being used for displaying recommendation description information of at least one candidate object corresponding to a target account, so that after the first client receives a selection operation on the recommendation description information of at least one target object among these candidate objects, updating the information configuration page by using the recommendation description information of these target objects, which allows the information configuration page to include the recommendation description information of the target objects; finally, after the first client receives a trigger operation on a second control (e.g., submission control) in the information configuration page, generating an object recommendation interface corresponding to the information configuration page, and the object recommendation interface being used for displaying the recommendation description information of these target objects, so that when the object recommendation interface is shown to a user, the user can view the recommendation description information of these target objects from the object recommendation interface, which can better meet the personalized product recommendation requirements of some merchants, thereby helping to improve the product recommendation experience of these merchants.

In addition, for the above information configuration page, the user of the first client only needs to execute some simple operations on the information configuration page, such as character input operation (e.g., inputting title content, etc.) and information selection operation (e.g., selecting the recommendation description information of some objects, etc.), without the need for executing other complicated operations (e.g., video data production, etc.). This can effectively simplify the production process of the above object recommendation interface, thereby helping to improve the user's interface production experience.

Actually, to better understand the recommendation method shown in S101-S104 above, the recommendation process in an application scenario will be described below.

As an example, in some application scenarios, the above information configuration page may be displayed by using a trigger operation on a control deployed in a certain page. Based on this, an embodiment of the present disclosure also provides a possible implementation mode of the above recommendation method applied to the first client. In this implementation mode, the recommendation method may include the following steps 11-15.

Step 11: the first client displaying an information management page, in which the information configuration page includes interface description information of at least one first recommendation interface corresponding to the above target account.

The first recommendation interface refers to a recommendation information aggregation card that has been created for the above target account. For example, the first recommendation interface may refer to a recommendation information aggregation card described by a product card list in FIG. 6.

The interface description information of the first recommendation interface is used for describing the first recommendation interface. Moreover, the above “interface description information of the first recommendation interface” is not limited by the embodiment of the present disclosure, for example, it may include a recommendation theme of the first recommendation interface, recommendation scenario description information of the first recommendation interface, timeliness information of the first recommendation interface, recommended object number description information of the first recommendation interface, and recommendation description information of recommended objects in the first recommendation interface. Here, the “recommendation theme of the first recommendation interface” is used for describing a content theme configured for the recommended object in the first recommendation interface (e.g., the string “theme 1” shown in FIG. 6). The “recommendation scenario description information of the first recommendation interface” is used for describing a business scenario configured for the recommended object in the first recommendation interface (e.g., the business scenario of “new product launch” shown in FIG. 6). The “timeliness information of the first recommendation interface” is used for describing a time period configured for the first recommendation interface that allows the second client below to perform recommendation and display (e.g., the promotion time period “time 1” shown in FIG. 6). The “recommended object number description information of the first recommendation interface” is used for describing an operation mode configured for the recommended object in the first recommendation interface (e.g., the operation mode “single item” shown in FIG. 6). The “recommendation description information of recommended objects in the first recommendation interface” refers to the recommendation description information of the recommended object selected in the first recommendation interface (e.g., the product name “product 1” shown in FIG. 6).

The above “information management page” is used for performing some management operations (e.g., offline control operation, etc.) on the interface description information of at least one first recommendation interface that has been created for the above target account. For example, the information management page may be the page 600 shown in FIG. 6.

Based on the related content of the step 11, it can be known that for the first client used by a certain merchant, when the first client is displaying the information management page (e.g., page 600 shown in FIG. 6) and the target account (e.g., the “first store” account shown in FIG. 6) has been selected on the information management page, the user of the first client can view the interface description information of all the first recommendation interfaces that have been created for the target account from the information management page, so that the user can perform corresponding management operations on the interface description information of these first recommendation interfaces (e.g., perform offline operation on a certain first recommendation interface, etc.).

Step 12: in response to a trigger operation on a third control in the information management page, the first client switching from the information management page to the information configuration page.

Here, the third control is used for triggering a creation process of a new recommendation information aggregation card. Moreover, the third control is not limited by the embodiment of the present disclosure, for example, it may be the control 601 shown in FIG. 6.

In addition, the above “trigger operation on a third control in the above information management page”is not limited by the embodiment of the present disclosure, for example, it may be a click operation.

Based on the related content of the step 12, it can be known that for the first client used by a certain merchant, when the first client is displaying the information management page (e.g., page 600 shown in FIG. 6), after the first client receives the trigger operation on the third control in the information management page (e.g., a click operation on the control 601 in FIG. 6), the first client switches from the information management page to the above information configuration page (e.g., switch from the page 600 in FIG. 6 to the page 200 in FIG. 2), so that the merchant can use the information configuration page to create a new recommendation information aggregation card that meets their personalized needs.

Step 13: in response to a trigger operation on a first control in the information configuration page, the first client displaying an object aggregation page, in which the object aggregation page includes recommendation description information of at least one candidate object corresponding to a target account.

It should be noted that for the related content of the step 13, please refer to the related content of the S102 above.

Step 14: in response to a selection operation on recommendation description information of at least one target object in the at least one candidate object, the first client updating the information configuration page by using the recommendation description information of the at least one target object.

It should be noted that for the related content of the step 14, please refer to the related content of the S103 above.

Step 15: in response to the trigger operation on the second control in the information configuration page, the first client generating the object recommendation interface corresponding to the information configuration page, switching from the information configuration page to the information management page, and updating the information management page by using interface description information of the object recommendation interface, in which the updated information management page includes the interface description information of the object recommendation interface and the interface description information of the at least one first recommendation interface.

The above “interface description information of object recommendation interface” is used for describing the object recommendation interface. Moreover, the “interface description information of object recommendation interface” is similar to the “interface description information of the first recommendation interface” above, and to facilitate understanding, examples are provided below for explanation.

As an example, when the above information configuration page (e.g., the page 400 shown in FIG. 4) includes a first configuration area, a second configuration area, a third configuration area, a fourth configuration area, a fifth configuration area and a sixth configuration area, the first configuration area is used for configuring the target account corresponding to the above object recommendation interface (e.g., the “first store” account shown in FIG. 4), the second configuration area is used for configuring a recommendation theme of the object recommendation interface (e.g., the content theme of “Hot Items * Limited Time Offer” shown in FIG. 4), the third configuration area is used for configuring recommendation scenario description information of the object recommendation interface (e.g., the business scenario of “promotion” shown in FIG. 4), the fourth configuration area is used for configuring timeliness information of the object recommendation interface (e.g., the promotion end time of “2022 Aug. 24” shown in FIG. 4), the fifth configuration area is used for configuring recommended object number description information of the object recommendation interface (e.g., “multiple items” shown in FIG. 4), and the sixth configuration area is used for selecting recommendation description information of at least one target object in the object recommendation interface (e.g., the product card of product 1 and the product card of product 2 shown in FIG. 4), then the interface description information of the object recommendation interface may include the recommendation theme of the object recommendation interface, the recommendation scenario description information of the object recommendation interface, the timeliness information of the object recommendation interface, the recommended object number description information of the object recommendation interface and the recommendation description information of recommended objects in the object recommendation interface.

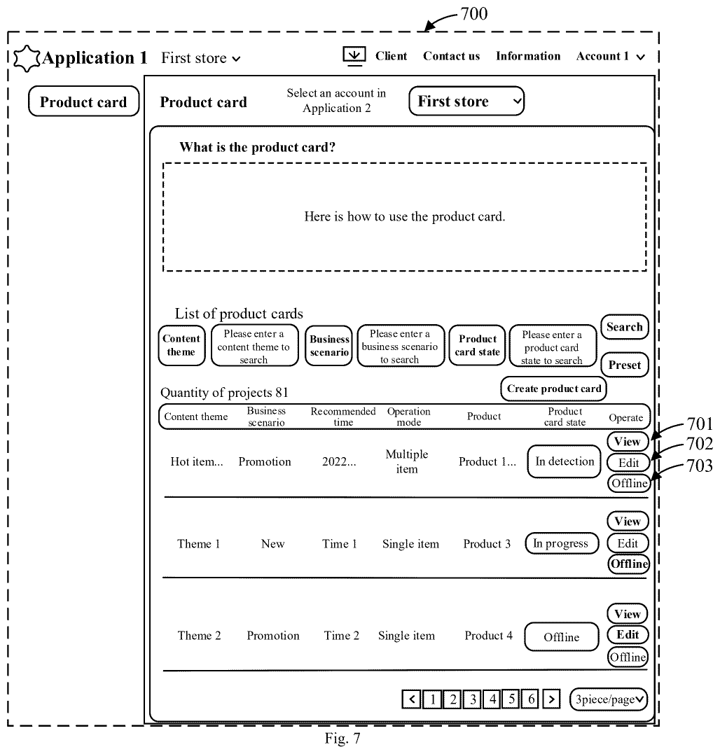

Based on the related content of the step 15, it can be known that for the first client used by a certain merchant, when the first client is displaying the information configuration page (e.g., the page 400 shown in FIG. 4), after receiving the trigger operation on the second control (e.g., the control 401 in FIG. 4) in the information configuration page, the first client generates the object recommendation interface (e.g., the interface 500 shown in FIG. 5) corresponding to the information configuration page, switches from the information configuration page to the information management page, and updates the information management page by using the interface description information of the object recommendation interface, so that the updated information management page (e.g., page 700 shown in FIG. 7) includes the interface description information of the object recommendation interface and the interface description information of the at least one first recommendation interface, thus implementing the purpose of creating a new recommendation information aggregation card for the merchant according to their personalized product recommendation requirements, which helps to improve the user experience.

Based on the related content of the steps 11 to 15, it can be known that for a first client (e.g., a client for providing store management services for a certain merchant), when the first client is displaying the information configuration page (e.g., the page 600 shown in FIG. 6), after receiving the trigger operation on the third control in the information management page (e.g., a click operation on the control 601 in FIG. 6), the first client switches to the above information configuration page, so that the user of the first client can configure a new recommendation information aggregation card by using the information configuration page, so as to generate the object recommendation interface (e.g., the interface 500 shown in FIG. 5) corresponding to the information configuration page after the first client receives the trigger operation on the second control in the information configuration page (e.g., a click operation on the control 401 in FIG. 4), switch from the information configuration page to the above information management page, and update the information management page by using the interface description information of the object recommendation interface. Thus, the updated information management page (e.g., the page 700 shown in FIG. 7) includes the interface description information of the object recommendation interface and the interface description information of the at least one first recommendation interface, thereby implementing the purpose of creating a new recommendation information aggregation card for the merchant according to their personalized product recommendation requirements, which helps to improve the user experience.

Actually, to improve the user experience, an embodiment of the present disclosure also provides another possible implementation mode of the above “interface description information of object recommendation interface”. In this implementation mode, the “interface description information of object recommendation interface” may also include state description information of the object recommendation interface. Here, the state description information is used for describing a real-time state of the object recommendation interface. Moreover, the state description information is not limited by the embodiment of the present disclosure, for example, it may be in detection, in progress, detection failed, or offline. “In detection” means that the object recommendation interface has been submitted but the detection has not been completed. “In progress” means that the object recommendation interface has passed the detection and has been published in the above application 2. “Detection failed” means that the object recommendation interface did not pass the detection. “Offline” means that the recommendation-display process of the object recommendation interface in the above application 2 has ended.

Based on this, it can be known that for the above object recommendation interface, in order to improve the display effect of the object recommendation interface, an embodiment of the present disclosure also provides a possible implementation mode of the recommendation method applied to the first client. In this implementation mode, the recommendation method may include not only the above steps 11-15, but also the following steps 16-17. The execution time of the step 16 is later than the execution time of the above step of “generating an object recommendation interface corresponding to the information configuration page”.

Step 16: the first client sending the object recommendation interface corresponding to the above information configuration page to a third client.

The third client is used for detecting a submitted recommendation information aggregation card (e.g., the above object recommendation interface). Moreover, the third client is not limited by the embodiment of the present disclosure, for example, it may be any client capable of communicating data with the first client.

Based on the related content of the step 16, it can be known that for the first client used by a certain merchant, after the first client generates the object recommendation interface corresponding to the information configuration page, the first client may send the object recommendation interface to the third client, so that a user of the third client can detect the object recommendation interface to avoid the presence of inappropriate and/or non-compliant content in the object recommendation interface, thereby effectively ensuring the display effect of the object recommendation interface.

Step 17: after receiving feedback information from the third client about the above object recommendation interface, the first client updating the state description information in the interface description information of the object recommendation interface on the above information management page according to the feedback information.

The feedback information is used for describing a detection result (e.g., passing the detection or the detection failed) of the object recommendation interface by the user of the third client.

In addition, a state of the above “state description information in the interface description information of the object recommendation interface” before the update is not limited by the embodiment of the present disclosure, for example, the state description information of the object recommendation interface before the update may be the string “in detection”as shown in FIG. 7.

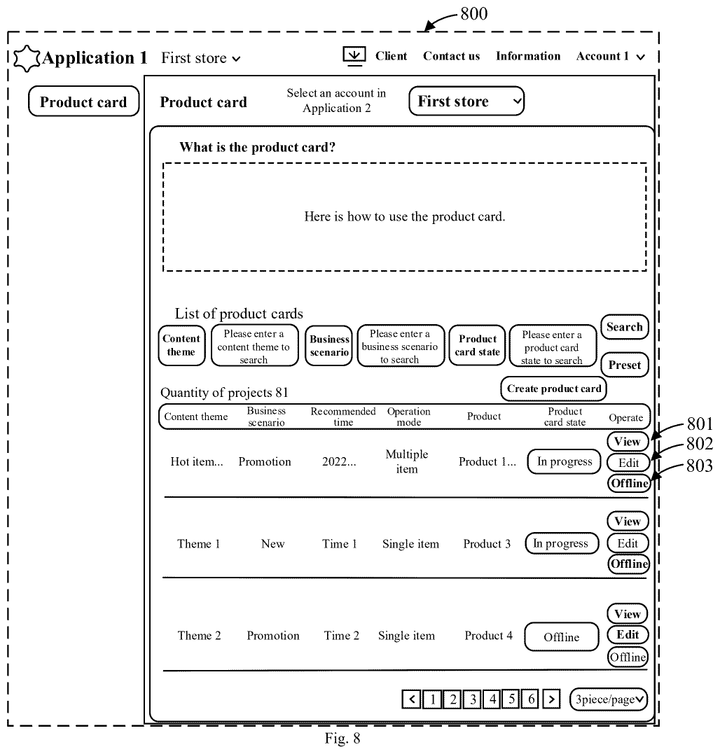

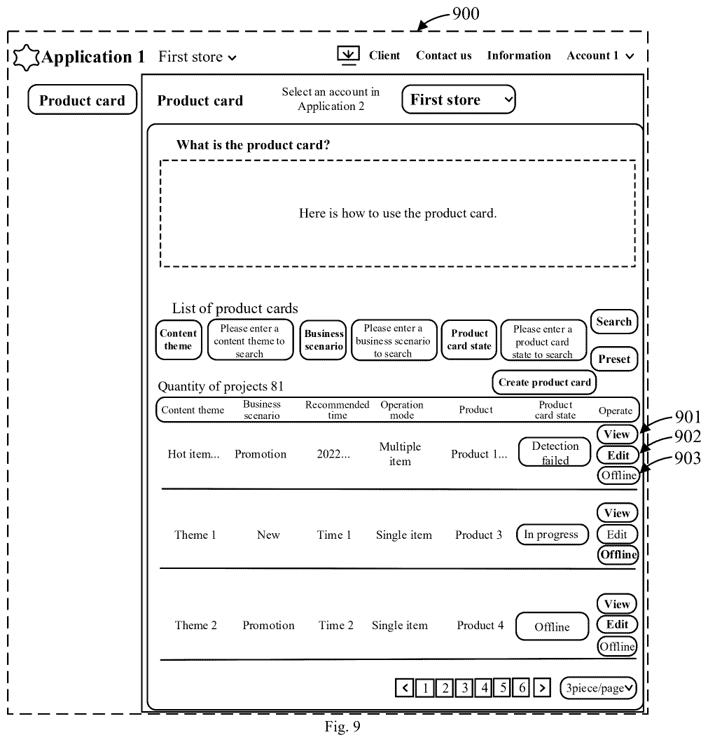

In addition, the implementation mode of the above step of “updating the state description information in the interface description information of the object recommendation interface on the above information management page according to the feedback information” is not limited by the embodiment of the present disclosure. For example, it may be specifically as follows: in response to the feedback information indicating that the object recommendation interface has passed the detection, then on the information management page, switching the state description information of the object recommendation interface from the first string (e.g., the string “in detection” shown in FIG. 7) to the second string (e.g., the string “in progress” shown in FIG. 8); however, in response to the feedback information indicating that the object recommendation interface fails to pass the detection, then on the information management page, switching the state description information of the object recommendation interface from the first string (e.g., the string “in detection” shown in FIG. 7) to the third string (the string “detection failed” shown in FIG. 9). Here, the first string is used for indicating that the object recommendation interface has been submitted but is in a detection stage, and the first string may be preset. The second string is used for indicating that the object recommendation interface has passed the detection, and the second string may be preset. The third string is used for indicating that the object recommendation interface fails to pass the detection, and the third string may be preset.

Based on the related content of the steps 16 to 17, it can be known that for the first client used by a certain merchant, when the first client is displaying the information management page and the state description information of the above object recommendation interface (e.g., the interface 500 shown in FIG. 5) is displayed on the information management page, in response to the object recommendation interface having been submitted but being in the detection stage, then the state description information of the object recommendation interface may be the string “in detection”, so as to immediately switch the state description information of the object recommendation interface from the string “in detection” to the string “in progress” when it is determined that the object recommendation interface has passed the detection. However, when it is determined that the object recommendation interface fails to pass the detection, the state description information of the object recommendation interface is immediately switched from the string “in detection” to the string “detection failed”. In this way, the purpose of updating the state description information of the object recommendation interface in real time according to the current state of the object recommendation interface can be achieved, thus effectively ensuring the real-time performance of the state description information of the object recommendation interface, which helps to improve the user experience.

Actually, each recommendation information aggregation card is time-sensitive, so in order to improve the user experience better, an embodiment of the present disclosure also provides a possible implementation mode of the recommendation method applied to the first client. In this implementation mode, the recommendation method may not only include some or all of the above steps (e.g., the steps 11-15or 11-17), but also include the following step 18. The execution time of the step 18 is later than that of the step 15.

Step 18: in response to reaching a preset offline condition, the first client adjusting the state description information in the interface description information of the object recommendation interface to first state description information on the above information management page, and/or sending an interface display end request corresponding to the object recommendation interface to the second client below, in which the interface display end request is used for requesting to end a recommendation-display process for the object recommendation interface.

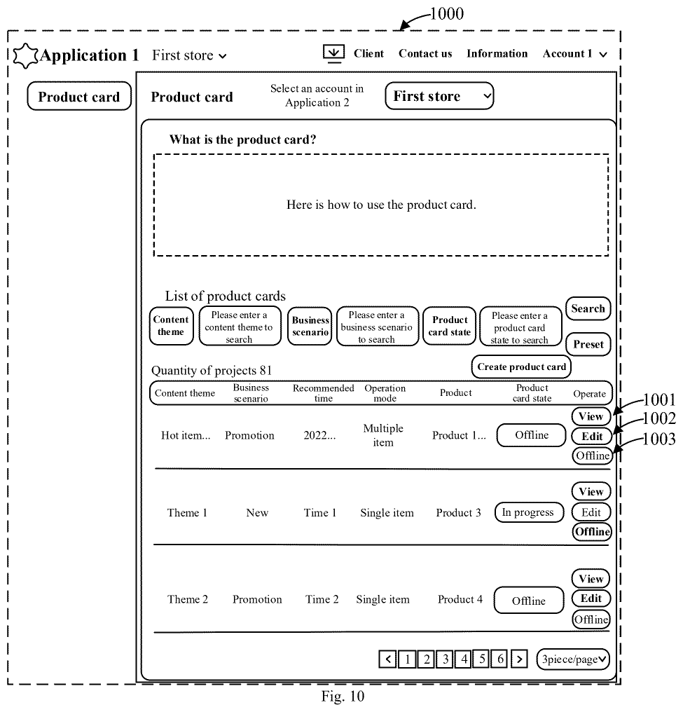

Here, the first state description information is used for indicating that the above object recommendation interface is in an offline state (that is, the recommendation-display process for the object recommendation interface has ended). Moreover, the first state description information is not limited by the embodiment of the present disclosure, for example, it may be a preset fourth string (e.g., the string “offline” shown in FIG. 10).

The above “interface display end request corresponding to the object recommendation interface” is used for requesting to end the recommendation-display process for the object recommendation interface (i.e., requesting the second client below not to display the object recommendation interface any more). Moreover, the “interface display end request corresponding to the object recommendation interface” is not limited by the embodiment of the present disclosure, for example, it may be implemented by any related or future request (e.g., instruction) with an information transmission function.

The second client refers to a client used for displaying the recommendation information aggregation card (e.g., the above object recommendation interface) created by the first client. Moreover, there is a preset association relationship between an account corresponding to the second client and the above target account. For example, when the target account is the “first store” account and the “first store” account is a user account that is created and used in the application 2, the account corresponding to the second client is also a user account that is created and used in the application 2. Moreover, the preset association relationship has been established between the account corresponding to the second client and the “first store” account, so that the account corresponding to the second client belongs to an associated user of the “first store” account.

The preset offline condition is used for describing the criteria that must be met for the recommendation information aggregation card to be taken offline (i.e., to end the recommendation-display process). Moreover, the preset offline condition is not limited by the embodiment of the present disclosure, and in order to facilitate understanding, two cases are described below.

In case 1, in some application scenarios, the first client may automatically determine whether the object recommendation interface needs be taken offline based on the timeliness information of the object recommendation interface.

Based on the above case 1, an embodiment of the present disclosure also provides a possible implementation mode of the above preset offline conditions. In this implementation mode, when the timeliness information of the above object recommendation interface includes a duration threshold (e.g., 7 days) corresponding to the object recommendation interface, the preset offline condition may specifically be that a publishing duration of the object recommendation interface exceeds the duration threshold corresponding to the object recommendation interface. Here, the publishing duration of the object recommendation interface is counted from the moment the object recommendation interface passes the detection, so that the publishing duration of the object recommendation interface can indicate how long the object recommendation interface has been recommended and displayed by the application 2.

Based on the above content, an embodiment of the present disclosure also provides a possible implementation mode of the step 18 above, which may specifically include: when a publishing duration of the above object recommendation interface is determined to meet a duration threshold corresponding to the object recommendation interface, the first client adjusting the state description information of the object recommendation interface to the first state description information on the above information management page, and/or sending an interface display end request corresponding to the object recommendation interface to the second client below, so as to prevent the second client from recommending and displaying the object recommendation interface, and also enable the user of the first client to know that the object recommendation interface has expired from the information management page (e.g., the page 1000 shown in FIG. 10).

In case 2, in some application scenarios, the user of the first client may manually control the above object recommendation interface to be taken offline in advance.

Based on the above case 2, an embodiment of the present disclosure also provides a possible implementation mode of the above preset offline conditions. In this implementation mode, when a first candidate control (e.g., the control 803 shown in FIG. 8) corresponding to the above object recommendation interface is displayed on the above information management page (e.g., the page 800 shown in FIG. 8), in response to the first candidate control corresponding to the object recommendation interface being in a first display state (e.g., the available state of the control 803 shown in FIG. 8), the preset offline condition may specifically be that the first client receives a trigger operation (e.g., a click operation) on the first candidate control corresponding to the object recommendation interface.

The above “first candidate control corresponding to the object recommendation interface” is used for triggering the offline processing flow for the object recommendation interface. Moreover, the “first candidate control corresponding to the object recommendation interface” is not limited by the embodiment of the present disclosure, for example, it may be the control 803 in FIG. 8.

The above “first display state” refers to a state presented when the “first candidate control corresponding to the object recommendation interface” can be triggered by the user. Moreover, the “first display state” is not limited by the embodiment of the present disclosure, for example, it may be the available state presented by the control 803 in FIG. 8.

In addition, the above “trigger operation on the first candidate control corresponding to the object recommendation interface” is not limited by the embodiment of the present disclosure, for example, it may be a click operation.

Based on the related content of the above case 2, an embodiment of the present disclosure also provides another possible implementation mode of the step 18 above. In this implementation mode, when the first candidate control (e.g., the control 803 shown in FIG. 8) corresponding to the above object recommendation interface is displayed on the above information management page (e.g., the page 800 shown in FIG. 8), in response to the first candidate control corresponding to the object recommendation interface being in the first display state (e.g., the available state of the control 803 shown in FIG. 8), the step 18 may specifically include: in response to a trigger operation on the first candidate control corresponding to the object recommendation interface, the first client adjusting the state description information of the object recommendation interface to the first state description information on the above information management page, and/or sending an interface display end request corresponding to the object recommendation interface to the second client below, so as to prevent the second client from recommending and displaying the object recommendation interface, and also enable the user of the first client to know that the object recommendation interface has expired from the information management page (e.g., the page 1000 shown in FIG. 10).

Based on the related content of the step 18 above, it can be known that for the first client used by a certain merchant, when the first client is displaying the information management page (e.g., the page 800 shown in FIG. 8) and the interface description information of the above object recommendation interface is displayed on the information management page, in response to determining that the preset offline condition is met, the first client may adjust the state description information in the interface description information of the object recommendation interface to the first state description information (e.g., the string “offline”) on the information management page, so that the user of the first client can know that the object recommendation interface is in an offline state from the information management page. Meanwhile, the first client may also send the interface display end request corresponding to the object recommendation interface to the second client below, so that the second client stops recommending and displaying the object recommendation interface, thereby implementing the control process of the recommendation-display duration for the object recommendation interface.

For the above “first candidate control corresponding to the object recommendation interface”, to improve the user experience better, the display state of the “first candidate control corresponding to the object recommendation interface” may be adjusted with the state description information of the object recommendation interface. Moreover, the adjustment process may be as follows. When the state description information of the object recommendation interface is the string “in detection”, it can be determined that the object recommendation interface is still not online (i.e., has not been published yet), then it can be determined that there is no offline control requirement for the object recommendation interface, so the “first candidate control corresponding to the object recommendation interface” can be in an opposite state of the above first display state (e.g., the unavailable state of the control 703 in FIG. 7), so that the opposite state can indicate that the “first candidate control corresponding to the object recommendation interface” cannot be triggered. When the state description information of the object recommendation interface is switched from the string “in detection” to the string “detection failed”, it can be determined that the object recommendation interface has a defect and cannot be online (i.e., cannot be published), then it can be determined that there is no offline control requirement for the object recommendation interface, so the “first candidate control corresponding to the object recommendation interface” can be in an opposite state of the first display state (e.g., the unavailable state of control 903 in FIG. 9), so that the opposite state can indicate that the “first candidate control corresponding to the object recommendation interface” cannot be triggered. However, when the state description information of the object recommendation interface is switched from the string “in detection” to the string “in progress”, it can be determined that the object recommendation interface has been online (i.e., has been published), then it can be determined that there is an offline control requirement for the object recommendation interface, so the “first candidate control corresponding to the object recommendation interface” can be in the first display state (e.g., the available state of control 803 in FIG. 8), so that the first display state can indicate that the “first candidate control corresponding to the object recommendation interface” can be triggered. When the state description information of the object recommendation interface is switched from the string “in progress” to the string “offline”, it can be determined that the object recommendation interface is offline, then it can be determined that there is no longer a need for offline control, so the “first candidate control corresponding to the object recommendation interface” can be in an opposite state of the first display state (e.g., the unavailable state of control 1003 in FIG. 10), so that the opposite state can indicate that the “first candidate control corresponding to the object recommendation interface” cannot be triggered. This effectively enhances the state control effectiveness of the “first candidate control corresponding to the object recommendation interface”, thereby effectively avoiding any confusion regarding the use of the “first candidate control corresponding to the object recommendation interface”.

Actually, in some cases, the user of the first client may also need to adjust the configuration information of a recommendation information aggregation card that has been created. Based on this, an embodiment of the present disclosure further provides a possible implementation mode of the recommendation method applied to the first client. In this implementation mode, the recommendation method may not only include some or all of the above steps (e.g., the steps 11-15), but also include the following step 19. The execution time of the step 19 is later than that of the step 15.

Step 19: when the updated information management page further includes a second candidate control corresponding to the object recommendation interface, and the second candidate control corresponding to the object recommendation interface is in a second display state, in response to a trigger operation on the second candidate control corresponding to the object recommendation interface, the first client switching from the information management page to an information configuration page corresponding to the object recommendation interface, so that the information configuration page is used for displaying an information configuration state of the object recommendation interface.

The above “second candidate control corresponding to the object recommendation interface” is used for triggering the configuration information adjustment process for the object recommendation interface. Moreover, the “second candidate control corresponding to the object recommendation interface” is not limited by the embodiment of the present disclosure, for example, it may be the control 902 in FIG. 9.

The above “second display state” refers to a state presented when the “second candidate control corresponding to the object recommendation interface” can be triggered by the user. Moreover, the “second display state” is not limited by the embodiment of the present disclosure, for example, it may be the available state presented by the control 902 in FIG. 9.

In addition, the above “trigger operation on the second candidate control corresponding to the object recommendation interface” is not limited by the embodiment of the present disclosure, for example, it may be a click operation.

The above “information configuration state of the object recommendation interface” refers to the state of the submitted object recommendation interface in the above information configuration page (e.g., the state of page 400 shown in FIG. 4).

Based on the related content of the step 19, it can be known that for the first client used by a certain merchant, when the first client is displaying the information management page (e.g., the page 900 shown in FIG. 9 or the page 1000 shown in FIG. 10), and the interface description information of the above object recommendation interface and the second candidate control (e.g., the control 902 in FIG. 9 or the control 1002 in FIG. 10) corresponding to the object recommendation interface are displayed on the information management page, in response to the second candidate control corresponding to the object recommendation interface being in the second display state, it can be determined that the second candidate control can be triggered. So after receiving the trigger operation on the second candidate control, the first client switches from the information management page (e.g., the page 900 shown in FIG. 9 or the page 1000 shown in FIG. 10) to an information configuration page corresponding to the object recommendation interface (e.g., the page 400 shown in FIG. 4), so that the information configuration page can show the information configuration state of the object recommendation interface, thus achieving the purpose of switching back to the information configuration page from the information management page. In this way, the user of the first client can adjust some configuration information in the information configuration page, so that the purpose of adjusting the configuration information of a recommendation information aggregation card that has been created can be achieved, thereby better meeting the requirements of the user of the first client.

For the above “second candidate control corresponding to the object recommendation interface”, to improve the user experience better, the display state of the “second candidate control corresponding to the object recommendation interface” may be adjusted with the state description information of the object recommendation interface. Moreover, the adjustment process may be as follows. When the state description information of the object recommendation interface is the string “in detection”, it can be determined that the object recommendation interface is detected, then it can be determined that the object recommendation interface cannot be edited, so the “second candidate control corresponding to the object recommendation interface” may be in an opposite state of the above second display state (e.g., the unavailable state of control 702 in FIG. 7), so that the opposite state can indicate that the “second candidate control corresponding to the object recommendation interface” cannot be triggered. When the state description information of the object recommendation interface is switched from the string “in detection” to the string “detection failed”, it can be determined that the object recommendation interface has a defect, then it can be determined that the object recommendation interface can be edited, so the “second candidate control corresponding to the object recommendation interface” can be in the second display state (e.g., the available state of control 902 in FIG. 9), so that the second display state can indicate that the “second candidate control corresponding to the object recommendation interface” can be triggered. However, when the state description information of the object recommendation interface is switched from the string “in detection” to the string “in progress”, it can be determined that the object recommendation interface has been online (i.e., has been published), then it can be determined that the object recommendation interface cannot be edited, so the “second candidate control corresponding to the object recommendation interface” can be in an opposite state of the third display state (e.g., the unavailable state of control 802 in FIG. 8), so that the opposite state can indicate that the “second candidate control corresponding to the object recommendation interface” cannot be triggered. When the state description information of the object recommendation interface is switched from the string “in progress” to the string “offline”, it can be determined that the object recommendation interface has expired, then it can be determined that the object recommendation interface can be edited, so the “second candidate control corresponding to the object recommendation interface” can be in the second display state (e.g., the available state of control 1002 in FIG. 10), so that the second display state can indicate that the “second candidate control corresponding to the object recommendation interface” can be triggered. This effectively enhances the state control effectiveness of the “second candidate control corresponding to the object recommendation interface”, thereby effectively avoiding any confusion regarding the use of the “second candidate control corresponding to the object recommendation interface”.

Actually, in some cases, a user of the first client may want to view the information details of a recommendation information aggregation card that the user have created. Based on this, an embodiment of the present disclosure further provides a possible implementation mode of the recommendation method applied to the first client. In this implementation mode, the recommendation method may not only include some or all of the above steps (e.g., the steps 11-15), but also include the following step 20, or steps 20-21.The execution time of the step 20 is later than that of the step 15.

Step 20: when the updated information management page includes a third candidate control corresponding to the object recommendation interface, in response to a trigger operation on the third candidate control corresponding to the object recommendation interface, the first client displaying an interface description page corresponding to the object recommendation interface on the information management page, so that the interface description page is used for displaying the object recommendation interface and the interface description information of the object recommendation interface.

The above “third candidate control corresponding to the object recommendation interface” is used for triggering the interface detail viewing process for the object recommendation interface. Moreover, the “third candidate control corresponding to the object recommendation interface” is not limited by the embodiment of the present disclosure, for example, it may be the control 701 shown in FIG. 7, the control 801 shown in FIG. 8, the control 901 shown in FIG. 9 or the control 1001 shown in FIG. 10.

In addition, the above “trigger operation on the third candidate control corresponding to the object recommendation interface” is not limited by the embodiment of the present disclosure, for example, it may be a click operation.

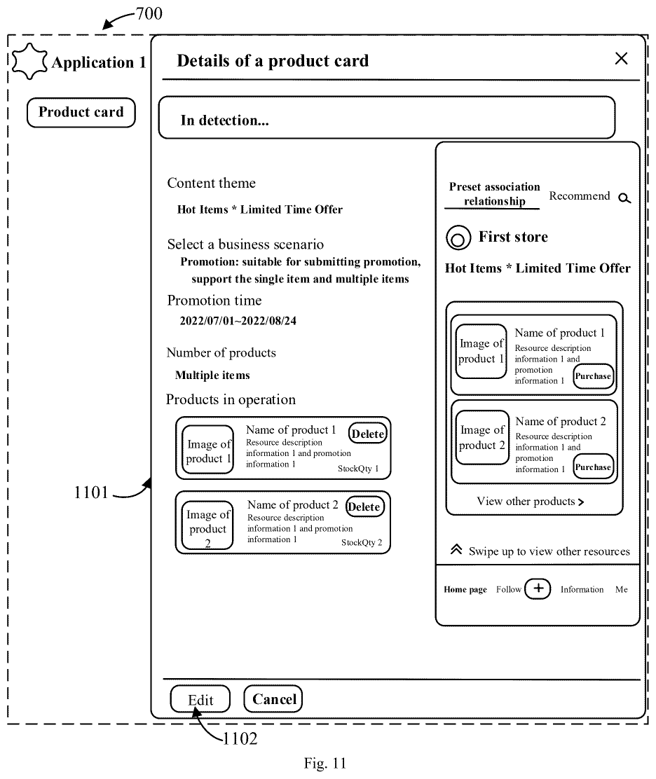

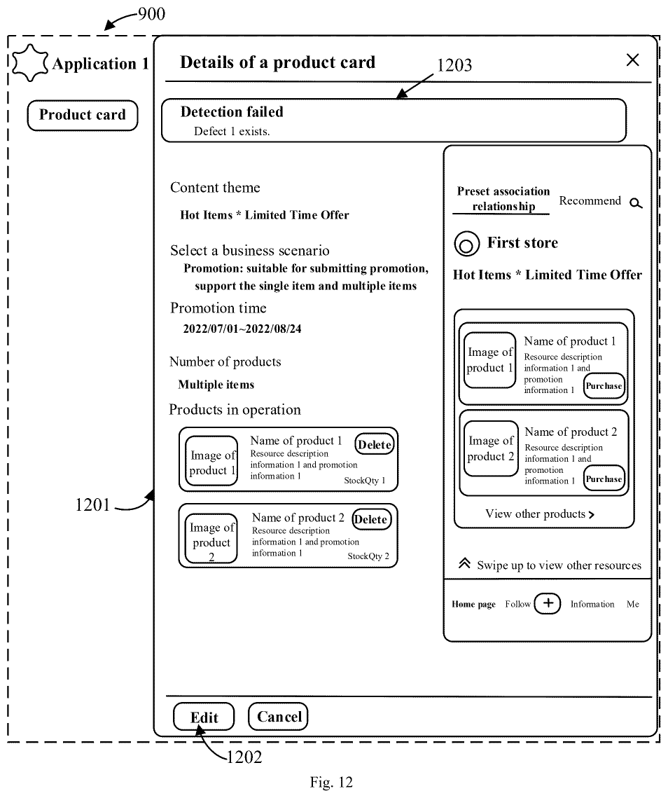

The above “interface description page corresponding to the object recommendation interface” is used for displaying the object recommendation interface and the related content of the object recommendation interface (e.g., the interface description information of the object recommendation interface). Moreover, the “interface description page corresponding to the object recommendation interface” is not limited by the embodiment of the present disclosure. For example, when the “updated information management page” is the page 700 shown in FIG. 7, the “interface description page corresponding to the object recommendation interface” may be the page 1101 shown in FIG. 11. For another example, when the “updated information management page” is the page 900 shown in FIG. 9, the “interface description page corresponding to the object recommendation interface”may be the page 1201 shown in FIG. 12.

In addition, to improve the user experience better, when the above object recommendation interface fails to pass the detection, the interface description page corresponding to the object recommendation interface may also display the reason why the object recommendation interface fails to pass the detection. Based on this, an embodiment of the present disclosure also provides another possible implementation mode of the above “interface description page corresponding to the object recommendation interface”. In the implementation mode, when the state description information in the interface description information of the object recommendation interface is the second state description information (e.g., the string “detection failed”), the “interface description page corresponding to the object recommendation interface” is also used for displaying prompt information corresponding to the second state description information (e.g., the content shown in the area 1203 of FIG. 11), so that the prompt information can indicate the reason why the object recommendation interface fails to pass the detection. Here, the second state description information is used for indicating that the object recommendation interface fails to pass the detection.

In addition, the implementation mode of the above step “displaying the interface description page corresponding to the object recommendation interface on the information management page” is not limited by the embodiment of the present disclosure, for example, it may specifically include: adding a side floating layer on the information management page, and displaying the interface description page corresponding to the object recommendation interface on the side floating layer.

Based on the related content of the step 20, it can be known that for the first client used by a certain merchant, when the first client is displaying the information management page (e.g., the page 700 shown in FIG. 7), and the interface description information of the above object recommendation interface and the third candidate control (e.g., the control 7 in FIG. 7) corresponding to the object recommendation interface are displayed on the information management page, after receiving the trigger operation on the third candidate control corresponding to the object recommendation interface, the first client displays the interface description page corresponding to the object recommendation interface (e.g., the page 1101 shown in FIG. 11) on the information management page, so that the interface description page can be used for displaying the object recommendation interface and the interface description information of the object recommendation interface, so that the user of the first client can learn the relevant information of the object recommendation interface from the interface description page.

Step 21: when a fourth control in the interface description page corresponding to the above object recommendation interface is in a third display state, in response to a trigger operation on the fourth control, the first client jumping to the information configuration page corresponding to the above object recommendation interface, so that the information configuration page is used for displaying the information configuration state of the above object recommendation interface.

The fourth control is used for triggering the configuration information adjustment process for the object recommendation interface. Moreover, the “fourth control” is not limited by the embodiment of the present disclosure. For example, when the above interface description page is the page 1201 shown in FIG. 12, the fourth control may be the control 1202 in FIG. 12.

The above “third display state” refers to a state presented when the above “fourth control in the interface description page” can be triggered by the user. Moreover, the “third display state” is not limited by the embodiment of the present disclosure, for example, it may be the available state presented by the control 1202 in FIG. 12.

Based on the related content of the step 21, it can be known that for the first client used by a merchant, when the first client is displaying the interface description page (e.g., page 1201 shown in FIG. 12) corresponding to the above object recommendation interface, in response to the fourth control in the interface description page being in the third display state (e.g., the available state of control 1202 in FIG. 12), after receiving the trigger operation on the fourth control, the first client jumps to the information configuration page corresponding to the object recommendation interface, so that the information configuration page can display the information configuration state of the object recommendation interface. In this way, the user of the first client can adjust some configuration information in the information configuration page, so that the purpose of adjusting the configuration information of a recommendation information aggregation card that has been created can be achieved, thereby better meeting the requirements of the user of the first client.

Actually, for the above fourth control, to improve the user experience better, the display state of the fourth control may also be adjusted with the state description information of the object recommendation interface, and the adjustment process may be as follows. When the state description information of the object recommendation interface is the string “in detection”, it can be determined that the object recommendation interface is detected, then it can be determined that the object recommendation interface cannot be edited, so the fourth control can be in an opposite state of the above third display state (e.g., the unavailable state of control 1102 in FIG. 11), so that the opposite state can indicate that the fourth control cannot be triggered. When the state description information of the object recommendation interface is switched from the string “in detection” to the string “detection failed”, it can be determined that the object recommendation interface has a defect, then it can be determined that the object recommendation interface can be edited, so the fourth control can be in the third display state (e.g., the available state of control 1202 in FIG. 12), so that the third display state can indicate that the fourth control can be triggered. However, when the state description information of the object recommendation interface is switched from the string “in detection” to the string “in progress”, it can be determined that the object recommendation interface has been online (i.e., has been published), then it can be determined that the object recommendation interface cannot be edited, so the fourth control can be in an opposite state of the third display state, so that the opposite state can indicate that the fourth control cannot be triggered. When the state description information of the object recommendation interface is switched from the string “in progress” to the string “offline”, it can be determined that the object recommendation interface has expired, then it can be determined that the object recommendation interface can be edited, so the fourth control can be in the third display state, so that the third display state can indicate that the fourth control can be triggered. This effectively enhances the state control effectiveness of the fourth control, thereby effectively avoiding any confusion regarding the use of the fourth control.

For the above information configuration page, because the information configuration page has much interface description information (e.g., there are 80 pieces of interface description information in the page 600 in FIG. 6, and 81 pieces of interface description information in the page 700 in FIG. 7), to meet the user's demand for viewing certain interface description information (e.g., interface description information under a certain content theme), an embodiment of the present disclosure also provides a possible implementation mode of the recommendation method applied to the first client. In this implementation mode, the recommendation method may not only include some or all of the above steps (e.g., the step 11), but also include the following step 22. The execution time of the step 22 is later than that of the step 11 or that of the step 15.

Step 22: when the first client is displaying the information management page (e.g., the page 600 shown in FIG. 6, the page 700 shown in FIG. 7, the page 800 shown in FIG. 8, the page 900 shown in FIG. 9, or the page 1000 shown in FIG. 10), and the information management page includes interface description information of at least one second recommendation interface (e.g., 80 pieces of interface description information shown in FIGS. 6, 81 pieces of interface description information shown in FIGS. 7, 81 pieces of interface description information shown in FIGS. 8, 81 pieces of interface description information shown in FIG. 9, or 81 pieces of interface description information shown in FIG. 10), in response to a condition input operation triggered on an information filtering condition input area in the information management page, the first client displaying the interface description information of a target recommendation interface among these second recommendation interfaces on the information management page. The interface description information of the target recommendation interface meets the information filtering condition corresponding to the condition input operation.

The above “interface description information of at least one second recommendation interface” refers to the interface description information existing in the above information management page. For example, when the execution time of the step 22 is later than that of the step 11, and the execution time of the step 22 is earlier than that of the step 12, the “interface description information of at least one second recommendation interface” may include the above “interface description information of at least one first recommendation interface”. For another example, when the execution time of the step 22 is later than that of the step 15, the “interface description information of at least one second recommendation interface” may include the above “interface description information of at least one first recommendation interface” and the above “interface description information of object recommendation interface”.

The above “information filtering condition input area” is used for providing an information filtering function for users of the above first client. Moreover, the “information filtering condition input area” is not limited by the embodiment of the present disclosure, for example, it may be an area that has an information inquiry function shown below the string “product card list” in FIG. 6.

The above “condition input operation” refers to an operation on the above “information filtering condition input area” by the user of the first client. Moreover, the “condition input operation” is not limited by the embodiment of the present disclosure. For example, it may include not only at least one selected from the group consisting of an operation for inputting search words related to subject content, an operation for inputting search words related to a business scenario, and an operation for inputting search words related to a product card state, but also a trigger operation on a query button (e.g., the query button shown in FIG. 6).

The above “information filtering condition corresponding to the condition input operation” refer to information filtering condition triggered by the condition input operation. For example, when the condition input operation at least includes the operation for inputting search words related to the subject content, the “information filtering condition corresponding to the condition input operation” may be determined according to the “search words related to the subject content”, so that based on the “information filtering condition corresponding to the condition input operation”, interface description information with subject content matching the search words can be retrieved.

The above “interface description information of the target recommendation interface” refers to interface description information that is filtered from the above “interface description information of at least one second recommendation interface” and meets the information filtering condition corresponding to the condition input operation.

Based on the related content of the step 22, it can be known that for the first client used by a certain merchant, when the first client is displaying the information management page (e.g., the page 600 shown in FIG. 6, the page 700 shown in FIG. 7, the page 800 shown in FIG. 8, the page 900 shown in FIG. 9, or the page 1000 shown in FIG. 10), and the information management page includes interface description information of at least one second recommendation interface (e.g., 80 pieces of interface description information shown in FIGS. 6, 81 pieces of interface description information shown in FIGS. 7, 81 pieces of interface description information shown in FIGS. 8, 81 pieces of interface description information shown in FIG. 9, or 81 pieces of interface description information shown in FIG. 10), after receiving the condition input operation on the information filtering condition input area in the information management page, the first client displays, on the information management page, interface description information that meets the information filtering condition corresponding to the condition input operation in the second recommendation interfaces. Thus, the purpose of selecting specific interface description information from the interface description information can be achieved, thereby effectively enhancing the information viewing experience for users of the first client.

Actually, for a certain merchant, the merchant may manage multiple stores. To improve the merchant's management experience for these stores, an embodiment of the present disclosure also provides a possible implementation mode of the recommendation method applied to the first client. In this implementation mode, the recommendation method may not only include some or all of the above steps (e.g., the step 11), but also include the following step 23. The execution time of the step 23 is later than that of the step 11 or that of the step 15.

Step 23: when the first client is displaying the information management page (e.g., the page 600 shown in FIG. 6, the page 700 shown in FIG. 7, the page 800 shown in FIG. 8, the page 900 shown in FIG. 9, or the page 1000 shown in FIG. 10), and the target account (e.g., the “first store” account) is displayed on the information management page, in response to an account switching operation triggered on an account input area in the information configuration page, on the information configuration page, the first client switching from the interface description information of at least one second recommendation interface corresponding to the target account to the interface description information of at least one third recommendation interface corresponding to an account to be used. Here, the account switching operation is used for switching from the target account to the account to be used in the account input area.

The account input area refers to an area used for selecting managed user accounts in the information management page, so that the user of the first client can input a user account (e.g., the above target account) that the user want to manage, is created and used in application 2 in the account input area. For example, the account input area may be the area 601 in FIG. 6.

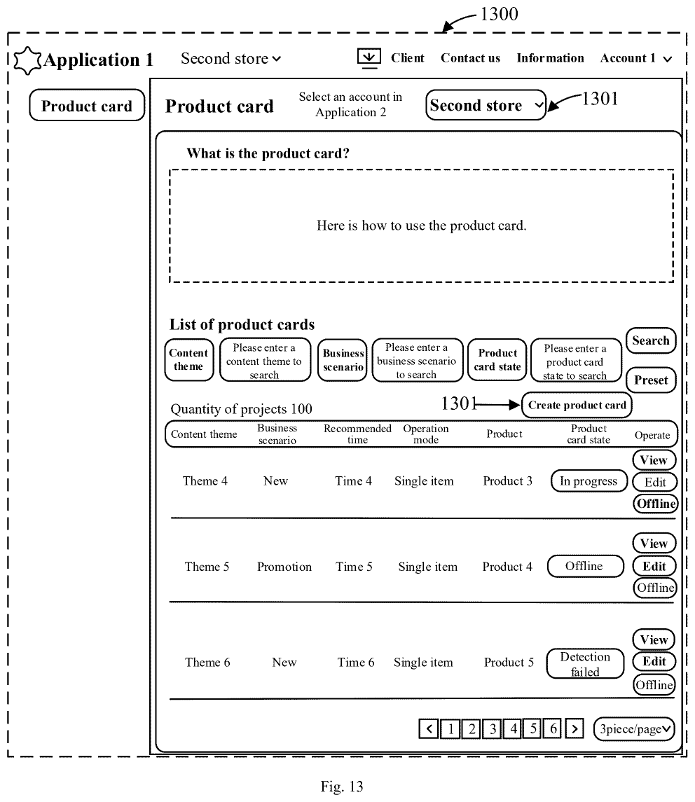

The account switching operation is used for switching from the above target account to the account to be used in the account input area. Moreover, the account switching operation is not limited by the embodiment of the present disclosure. For example, when the account input area is the area 601 in FIG. 6, the account switching operation may specifically be as follows: first clicking a dropdown menu identifier “∨” in the area 601 to open a dropdown menu corresponding to the identifier, in which the dropdown menu includes at least one candidate account; and then selecting, from these candidate accounts, a candidate account that is different from the above target account (e.g., the “second store” account shown in FIG. 13) as the account to be used, so that the account input area (e.g., the area 1301 in FIG. 13) can display the account to be used. The candidate account refers to an account that can be managed by the user of the first client.

The above “third recommendation interface” refers to a recommendation information aggregation card that has been created for the account to be used. The interface description information of the third recommendation interface is used for describing the third recommendation interface. For example, the above “interface description information of at least one third recommendation interface” may include 100 pieces of interface description information shown in the page 1300 of FIG. 13.

Based on the related content of the step 23, it can be known that for the first client used by a certain merchant, when the first client is displaying the information management page (e.g., the page 600 shown in FIG. 6, the page 700 shown in FIG. 7, the page 800 shown in FIG. 8, the page 900 shown in FIG. 9, or the page 1000 shown in FIG. 10), and the target account (e.g., the “first store” account) is displayed on the information management page, after the first client receives the account switching operation on the account input area in the information configuration page, in response to the account switching operation being used for switching from the above target account (e.g., the “first store” account) to the account to be used (e.g., the “second store” account shown in FIG. 13) in the account input area, on the information configuration page, the interface description information of at least one second recommendation interface corresponding to the target account is switched to the interface description information of at least one third recommendation interface corresponding to the account to be used, so that the user of the first client can continue to manage all the interface description information under the account to be used, thus meeting the requirements of the user of the first client for managing multiple accounts, which helps to improve the information management experience of the user.

Actually, the object recommendation interface that has passed the detection can be directly sent to the second client for recommendation and display, so that the user of the second client can see the object recommendation interface in time. Based on this, an embodiment of the present disclosure further provides a possible implementation mode of the recommendation method applied to the first client. In this implementation mode, the recommendation method may not only include some or all of the above steps (e.g., the steps 11-17), but also include the following step 24. The execution time of the step 24 is later than the execution time of the above step of “generating an object recommendation interface corresponding to the information configuration page”.

Step 24: in response to a preset sending condition being met, the first client sending the above object recommendation interface to the second client, in which a preset association relationship exists between an account corresponding to the second client and the target account, and the second client is used for displaying the object recommendation interface on a resource display page corresponding to a preset tag.

Here, the preset sending condition refers to the criteria that must be met by the recommendation information aggregation card that requires to use the second client for recommendation and display. Moreover, the preset sending condition is not limited by the embodiment of the present disclosure, for example, the preset sending condition may specifically be that the above object recommendation interface has passed the detection.

Please refer to the related content of the S1501 below for the related content of the second client.

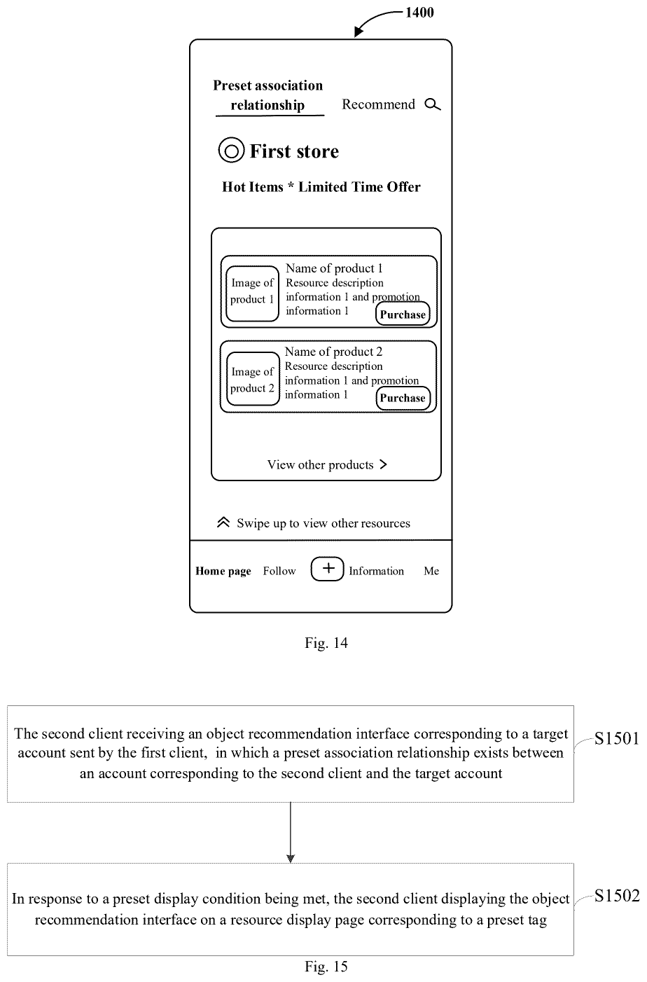

The above “preset tag” refers to a tag that is preset, for example, it may be the “preset association relationship” tag in FIG. 14.

The “resource display page corresponding to the preset tag” is used for displaying a resource stream corresponding to the preset tag. For example, when the preset tag is the “preset association relationship” tag, the “resource display page corresponding to the preset tag” may be the page 1400 in FIG. 14, so that the “resource display page corresponding to the preset tag” can show the user some resource data (e.g. short video data, live video data, the above recommendation information aggregation card, etc.) published by some other user accounts that have a preset association relationship with the account corresponding to the second client.

Actually, for a user of the second client, on the “resource display page corresponding to the preset tag”, the user can view some information published by the accounts that have a preset association relationship with the user. Based on this, an embodiment of the present disclosure also provides a possible implementation mode of the above second client. In this implementation mode, before the second client receives the above object recommendation interface, in response to the second client being used for displaying at least one resource to be displayed in a first order on the resource display page corresponding to the preset tag, the second client may update the at least one resource to be displayed by using the object recommendation interface after receiving the object recommendation interface, so that at least one resource to be displayed after the update includes the object recommendation interface and the at least one resource to be displayed before the update; then the second client displays the at least one resource to be displayed after the update according to a target order, so that the purpose of updating the resource stream corresponding to the preset tag by using the recommendation information aggregation card published by the first client can be achieved, allowing the user of the second client to view the object recommendation interface from the resource display page corresponding to the preset tag, thereby achieving the purpose of recommending and displaying the object recommendation interface to the user of the second client (i.e., the associated user of the target account).

The “resources to be displayed” above refer to resource data that can be displayed on the resource display page corresponding to the preset tag above. Moreover, the resources to be displayed are not limited by the embodiment of the present disclosure, for example, they may be video data (e.g., short video data or live video data), information cards (e.g., recommendation information aggregation cards that are similar to the above “object recommendation interface”), and other resource data.

The above “first order” refers to the arrangement order among the above “at least one resource to be displayed before the update”.

The above “target order” refers to the arrangement order among the above “at least one resource to be displayed after the update”.

Based on the related content of the step 24, it can be known that for the first client used by a certain merchant, after the first client generates the object recommendation interface corresponding to the above information configuration page, the first client may first send the object recommendation interface to the third client, so that the third client can detect the object recommendation interface. After the first client receives a detection result for the object recommendation interface fed back by the third client, in response to the detection result indicating that the object recommendation interface has passed the detection, the first client may determine that the object recommendation interface meets the preset sending condition, and then the first client sends the object recommendation interface to the second client, allowing the second client to display the object recommendation interface by using the resource display page corresponding to the preset tag. In this way, the user of the second client can view the object recommendation interface from the resource display page corresponding to the preset tag, thus achieving the purpose of displaying the recommendation information aggregation card created by the merchant to associated users.

Actually, to improve the user experience better, an embodiment of the present disclosure also provides a possible implementation mode of the recommendation method applied to the first client. In this implementation mode, the recommendation method not only includes all or part of the above steps, but also includes the following steps 1-2. The execution time of the step 1 is later than that of the S101.

Step 1: in response to a trigger operation on a fifth control in the above information configuration page, displaying a template configuration page.

The fifth control is used for triggering a display process for the template configuration page. Moreover, the fifth control is not limited by the embodiment of the present disclosure.

In addition, the above “trigger operation on a fifth control in the above information configuration page” is not limited by the embodiment of the present disclosure, for example, it may be a click operation.

The template configuration page is used for configuring a page layout of the recommendation information aggregation card. Moreover, the template configuration page is not limited by the embodiment of the present disclosure. For example, a large number of aggregation card templates are displayed in the template configuration page, so that the users can select one of these aggregation card templates to create the recommendation information aggregation card. For another example, some components are deployed on the template configuration page, so that the users can create a recommendation information aggregation card that meets their personalized needs by using these components.

Step 2: in response to a template updating operation triggered on the template configuration page, updating the information configuration page by using a recommendation interface template corresponding to the template updating operation, in which the updated information configuration page is used for displaying at least one information configuration item in the recommendation interface template.

The template updating operation is used for triggering an updating process for the aggregation card template. Moreover, the template updating operation is not limited by the embodiment of the present disclosure.

The above “recommendation interface template corresponding to the template updating operation” refers to a new aggregation card template determined by using the template updating operation in the template configuration page.

Based on the related content of the steps 1 to 2, it can be known that the user of the first client can not only configure what is displayed in a recommendation information aggregation card by using the above information configuration page, but also configure the page layout of the recommendation information aggregation card, so that the recommendation information aggregation card can better meet the personalized needs of the user, which helps to improve the user experience.

Based on the related content of the recommendation method applied to the first client, an embodiment of the present disclosure also provides a recommendation method applied to a second client, as shown in FIG. 15. The recommendation method applied to the second client provided by the embodiment of the present disclosure includes the following steps S1501-S1502.

In S1501: the second client receiving an object recommendation interface corresponding to a target account sent by the first client, in which a preset association relationship exists between an account corresponding to the second client and the target account.

The second client refers to a client where an account having a preset association relationship with the above target account is logged in, so that the second client can be used for recommending and displaying a recommendation information aggregation card generated by the first client (e.g., the above object recommendation interface).

Therefore, a preset association relationship exists between the account corresponding to the second client and the above target account. For example, when the target account is the “first store” account and the “first store” account is a user account that is created and used in the application 2, the account corresponding to the second client is also a user account that is created and used in the application 2. Moreover, a preset association relationship has been established between the account corresponding to the second client and the “first store” account, so that the account corresponding to the second client belongs to an associated user of the “first store”account.

The above “object recommendation interface corresponding to the target account” is the object recommendation interface mentioned in the above recommendation method applied to the first client, which will not be further repeated here for the sake of brevity. For example, the object recommendation interface corresponding to the target account may be the interface 500 shown in FIG. 5.

Based on the related content of the step 1501, it can be known that for the above second client (i.e., the client used by the associated user of the above target account), after the second client receives the object recommendation interface corresponding to the target account sent by the above first client, the second client may display the object recommendation interface to the user of the second client (i.e., a certain associated user of the target account) in a certain way (e.g., the way shown in S1502 below), so that the purpose of displaying the recommendation information aggregation card created by the merchant to the associated user can be achieved.

In S1502: in response to a preset display condition being met, the second client displaying the object recommendation interface on a resource display page corresponding to a preset tag.

The preset display condition may be preset according to application scenarios. To facilitate understanding, the explanation below will be based on the display process of the above object recommendation interface.

In a possible implementation mode, the display process of the above object recommendation interface may specifically include the following steps 31-32. The execution time of the step 31 is later than that of the S1501 above.

Step 31: the second client using the above object recommendation interface to update at least one resource to be displayed corresponding to the above preset tag, so that the at least one resource to be displayed after the update is arranged according to a target order, a position of a first resource in the at least one resource to be displayed after the update is adjacent to a position of the object recommendation interface in the target order, and the position of the first resource in the target order is ahead of the position of the object recommendation interface in the target order.

The “resources to be displayed” above refer to resource data that can be displayed on the resource display page corresponding to the preset tag above. Moreover, the resources to be displayed are not limited by the embodiment of the present disclosure, for example, they may be video data (e.g., short video data or live video data), information cards (e.g., recommendation information aggregation cards similar to the above “object recommendation interface”), and other resource data.

It can be seen that in a possible implementation mode, for at least one resource to be displayed before the update, the at least one resource to be displayed before the update may include at least one video datum. Here, the video data may be short video data or live video data. That is, the at least one resource to be displayed before the update may include at least one short video datum and/or at least one live video datum. It should be noted that an acquisition process for the “at least one video datum” is not limited by the embodiment of the present disclosure, for example, it may be implemented by any related or future method for acquiring a video data stream corresponding to the “preset association relationship” tag.

The above “at least one resource to be displayed after the update” includes at least one resource to be displayed before the update and the above object recommendation interface. Moreover, a determination process for the “at least one resource to be displayed after the update” is not limited by the embodiment of the present disclosure, and for example, it may be specifically as follows. After receiving the object recommendation interface, the second client may insert the object recommendation interface into a resource queue formed by the above “at least one resource to be displayed before the update” to obtain the at least one resource to be displayed after the update arranged in the target order. Here, in the resource queue formed by the above “at least one resource to be displayed before the update”, these resources to be displayed before the update are arranged in the first order.

In addition, for the “at least one resource to be displayed after the update”, in response to the “at least one resource to be displayed after the update” being arranged in the target order, when the position of the first resource in the at least one resource to be displayed after the update is adjacent to the position of the object recommendation interface in the target order, and the position of the first resource in the target order is ahead of the position of the object recommendation interface in the target order, then it can be determined that a display time of the first resource on the resource display page corresponding to the preset tag is earlier than that of the object recommendation interface on the resource display page, and the resource display page allows for directly switching from the first resource to the object recommendation interface. It can be seen that the first resource refers to a resource preceding the object recommendation interface in the resource queue formed by the at least one resource to be displayed after the update.

Step 32: when the first resource is displayed on the resource display page corresponding to the preset tag, in response to a second operation triggered on the resource display page, the second client displaying the object recommendation interface on the resource display page.

The second operation is used for triggering a resource switching process on the resource display page corresponding to the preset tag. Moreover, the second operation is not limited by the embodiment of the present disclosure, for example, it may be the operation indicated by the string “swipe up to see more resources” in FIG. 14 (i.e., a swipe-up operation).

Based on the related content of the steps 31 to 32, it can be known that for the above second client (i.e., the client used by the associated user of the above target account), after the second client receives the object recommendation interface corresponding to the target account sent by the above first client, the second client may first update the at least one resource to be displayed by using the object recommendation interface, so that the object recommendation interface exists in the at least one resource to be displayed after the update. However, when the at least one resource to be displayed after the update is arranged in the target order, the position of the first resource in the at least one resource to be displayed after the update is adjacent to the position of the object recommendation interface in the target order, and the position of the first resource in the target order is ahead of the position of the object recommendation interface in the target order, in response to the resource display page corresponding to the preset tag being displaying the first resource, then after the second client receives the second operation triggered on the resource display page, the object recommendation interface is displayed on the resource display page, so that the purpose of displaying the recommendation information aggregation card created by the merchant to associated users can be achieved.

Based on the related content from the S1501 to S1502, it can be known that for the above second client (i.e., the client used by the associated user of the above target account), after the second client receives the object recommendation interface corresponding to the target account sent by the above first client, the second client may first use the object recommendation interface to update a resource stream of the resource display page corresponding to the above preset tag (i.e., at least one resource to be displayed above), so that the object recommendation interface exists in the updated resource stream, allowing the second client to display the updated resource stream on the resource display page corresponding to the preset tag, thus achieving the purpose of displaying the recommendation information aggregation card created by the merchant to associated users.

Actually, to improve the merchant's control effect of the display of recommendation information aggregation cards, an embodiment of the present disclosure also provides a possible implementation mode of the recommendation method applied to the second client. In this implementation mode, when the recommendation method at least includes the above step 31, the recommendation method may further include the following steps 33-34. The execution time of the step 33 is later than that of the step 31 above.

Step 33: the second client receiving an interface display end request corresponding to the object recommendation interface sent by the first client.

The interface display end request is used for requesting that the object recommendation interface no longer be displayed (i.e., to end the recommendation-display process for the object recommendation interface).

In addition, a triggering mode of the above interface display end request is not limited by the embodiment of the present disclosure. For example, when the first client determines that the above object recommendation interface meets a preset offline condition, the first client may send the interface display end request to the second client, so that the second client can end the recommendation-display process for the object recommendation interface based on the interface display end request. It should be noted that the relevant content of the preset offline condition can be found in the step 18 above, which will not be repeated here for brevity.

Step 34: the second client deleting the above object recommendation interface from the at least one resource to be displayed after the update.

Based on the related content of the steps 33 to 34, it can be known that for the above second client (i.e., the client used by the associated user of the above target account), after the second client updates the resource stream of the resource display page corresponding to the above preset tag (i.e., at least one resource to be displayed above) by using the above object recommendation interface, it can be determined that the object recommendation interface exists in the updated resource stream. Therefore, after the second client receives the interface display end request corresponding to the object recommendation interface sent by the first client, it can be determined that the user of the first client does not want to continue recommending and displaying the object recommendation interface, so the second client can remove the object recommendation interface from the updated resource stream, so that the user of the second client will not see the object recommendation interface any more, which can effectively improve the control effect of the display process of the object recommendation interface by the user of the first client, thereby improving the user experience for the user of the first client.

Actually, for the resource display page corresponding to the preset tag, when a recommendation information aggregation card (e.g., the interface 500 shown in FIG. 5) is displayed on the resource display page, the resource display page may perform corresponding information display processing based on some interactive operations triggered by the user. To facilitate understanding, some examples will be provided below for explanation.

Example 1: in some cases, when the resource display page is displaying a recommendation information aggregation card (e.g., the interface 500 shown in FIG. 5), the resource display page may switch to other resources for display in response to a swipe-up operation triggered by the user.

Based on this, an embodiment of the present disclosure also provides a possible implementation mode of the recommendation method applied to the second client. In this implementation mode, when the recommendation method at least includes the above steps 31-32, the recommendation method may further include the following step 35. The execution time of the step 35 is later than that of the step 32 above.

Step 35: when a position of a second resource in the at least one resource to be displayed after the update is adjacent to the position of the object recommendation interface in the target order, and the position of the second resource in the target order is behind the position of the object recommendation interface in the target order, the second client displaying the second resource on the resource display page in response to a second operation on the resource display page corresponding to the preset tag.

Here, the second resource refers to a resource behind the object recommendation interface in the resource queue formed by the at least one resource to be displayed after the update.

In addition, the “second operation on the resource display page corresponding to the preset tag” in the step 35 is the same as the “second operation on the resource display page” in the step 32, which will not be repeated here for the sake of brevity.

Based on the related content of the step 35, it can be known that for the above second client (i.e., the client used by the associated user of the above target account), when the second client is displaying the resource display page corresponding to the above preset tag (e.g., the page 1400 shown in FIG. 14) and the resource display page is displaying the above object recommendation interface (e.g., the interface 500 shown in FIG. 5), after the second client receives the second operation (e.g., swipe-up operation) on the resource display page, the display content on the resource display page is switched from the object recommendation interface to the resource behind the object recommendation interface (i.e., the above second resource), so as to meet the need of the user of the second client for viewing other resources.

Example 2: in some cases, when the resource display page corresponding to the preset tag is displaying a recommendation information aggregation card (e.g., the interface 500 shown in FIG. 5), and the recommendation information aggregation card is used for displaying some products provided by the above target account, the viewer of the recommendation information aggregation card may not want to see the recommendation information aggregation card provided by the target account (or may not want to see the recommendation information aggregation card provided by any account), so to meet the user's need, the viewer may use specific interactive operations triggered for the recommendation information aggregation card to achieve it. To facilitate understanding, six implementation methods will be provided below for explanation.

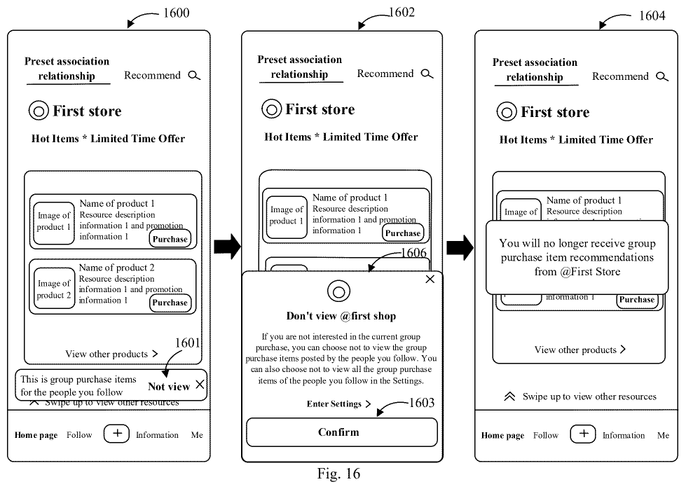

Method 1: for the above second client, when the second client is displaying the resource display page (e.g., the page 1600 in FIG. 16) corresponding to the above preset tag, in response to a recommendation information aggregation card (e.g., the recommendation information aggregation card shown in the page 1600 of FIG. 16) being displayed on the resource display page for the first time, the first-time reach prompt information (e.g., the string “This is a group purchase item published by your associated contact” in FIG. 16) and the sixth control (e.g., the control 1601 in FIG. 16) are also displayed on the resource display page, so as to display the first dropdown page (e.g., the page 1606 in FIG. 16) on the resource display page (e.g., the page 1602 in FIG. 16) after the second client receives a trigger operation (e.g., click operation) on the sixth control. Then, after receiving a trigger operation (e.g., click operation) on the seventh control (e.g., the control 1603 in FIG. 16) in the first dropdown page, the second client closes the first dropdown page and displays the first prompt content (e.g., the string “You will no longer receive group purchase item recommendations from @First Store” shown in the area 1605 of FIG. 16) on the resource display page (e.g., the page 1604 in FIG. 16). This ensures that the user of the second client will no longer see any recommendation information aggregation cards published by the account corresponding to the recommendation information aggregation card.

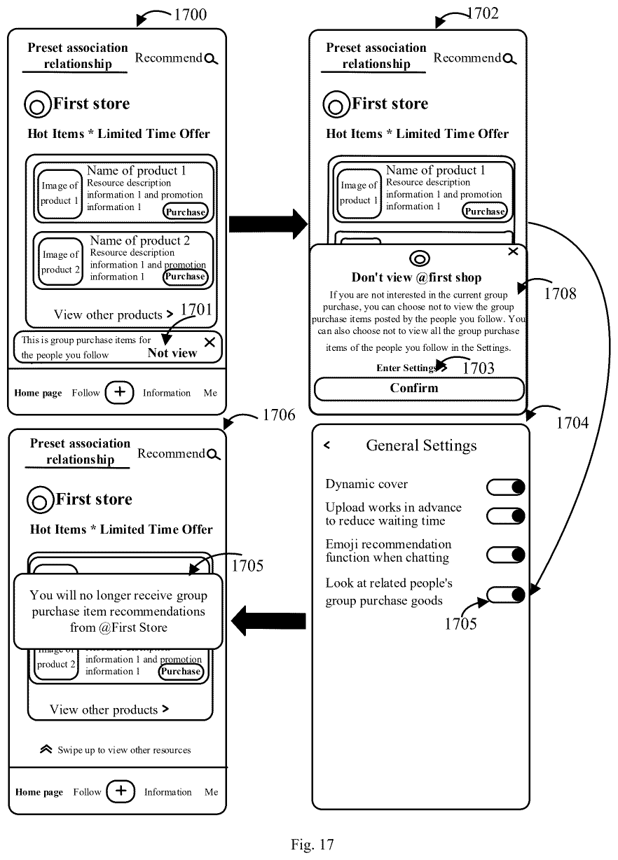

Method 2: for the above second client, when the second client is displaying the resource display page (e.g., the page 1700 in FIG. 17) corresponding to the above preset tag, in response to a recommendation information aggregation card (e.g., recommendation information aggregation card shown in the page 1700 of FIG. 17) being displayed on the resource display page for the first time, the first-time reach prompt information (e.g., the string “This is a group purchase item published by your associated contact” in FIG. 17) and the sixth control (e.g., the control 1701 in FIG. 17) are also displayed on the resource display page, so as to display the first dropdown page (e.g., the page 1708 in FIG. 17) on the resource display page (e.g., the page 1702 in FIG. 17) after the second client receives a trigger operation (e.g., click operation) on the sixth control. Then, after receiving a trigger operation (e.g., click operation) on the eighth control (e.g., the control 1703 in FIG. 17) in the first dropdown page, the second client jumps to a general settings page (e.g., the page 1704 in FIG. 17). Subsequently, after receiving a trigger operation (e.g., click operation) on the ninth control (e.g., the control 1705 corresponding to the string “View group purchase items from associated contacts” in FIG. 17) in the general settings page, the second client jumps from the general settings page to the resource display page (e.g., the page 1706 in FIG. 17) and displays the first prompt information (e.g., the string “You will no longer receive group purchase item recommendations from @First Store” shown in the area 1707 of FIG. 17) on the resource display page. This ensures that the user of the second client will no longer see any recommendation information aggregation cards published by the account corresponding to the recommendation information aggregation card.

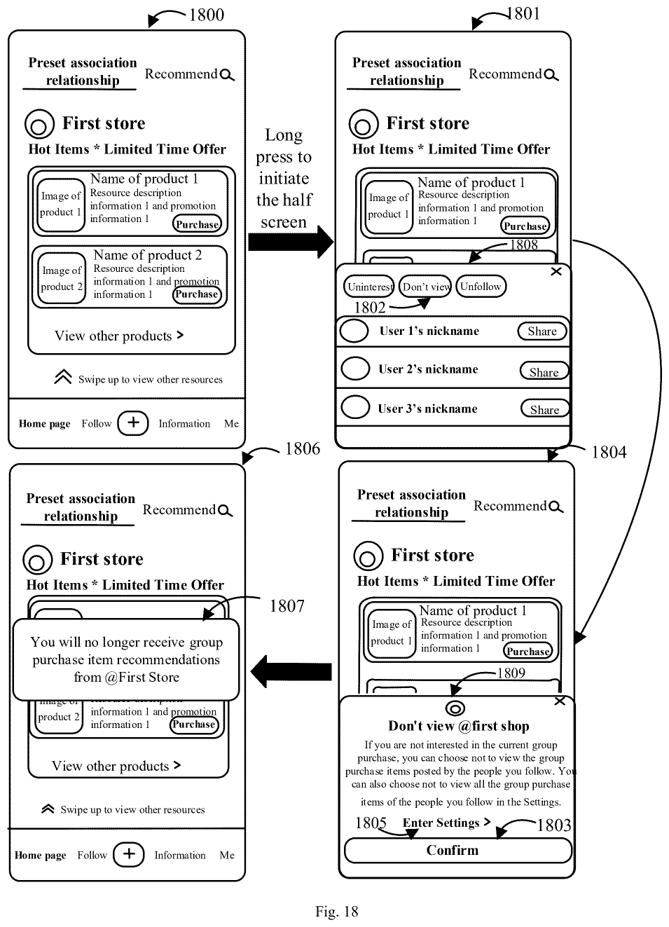

Method 3: for the above second client, when the second client is displaying the resource display page (e.g., the page 1800 in FIG. 18) corresponding to the above preset tag, after the second client receives the third operation (e.g., the “long press” operation shown in FIG. 18) on the resource display page, the second dropdown page (e.g., the page 1808 in FIG. 18) is displayed on the resource display page (e.g., the page 1801 in FIG. 18). Then, after the second client receives a trigger operation (e.g., click operation) on the tenth control (e.g., the control 1802 in FIG. 18) in the second dropdown page, the second dropdown page is switched to the first dropdown page (e.g., the page 1809 in FIG. 18) on the resource display page (e.g., the page 1804 in FIG. 18). Subsequently, after receiving a trigger operation (e.g., click operation) on the seventh control (e.g., the control 1803 in FIG. 18) in the first dropdown page, the second client closes the first dropdown page and displays the first prompt content (e.g., the string “You will no longer receive group purchase item recommendations from @First Store” shown in the area 1807 of FIG. 18) on the resource display page (e.g., the page 1806 in FIG. 18). This ensures that the user of the second client will no longer see any recommendation information aggregation cards published by the account corresponding to the recommendation information aggregation card.

Method 4: for the above second client, when the second client is displaying the resource display page (e.g., the page 1800 in FIG. 18) corresponding to the above preset tag, after the second client receives the third operation (e.g., the “long press” operation shown in FIG. 18) on the resource display page, the second dropdown page (e.g., the page 1808 in FIG. 18) is displayed on the resource display page (e.g., the page 1801 in FIG. 18). Then, after the second client receives a trigger operation (e.g., click operation) on the tenth control (e.g., control 1802 in FIG. 18) in the second dropdown page, the second dropdown page is switched to the first dropdown page (e.g., the page 1809 in FIG. 18) on the resource display page (e.g., the page 1804 in FIG. 18). Then, after receiving a trigger operation (e.g., click operation) on the eighth control (e.g., the control 1805 in FIG. 18) in the first dropdown page, the second client jumps to a general settings page (e.g., page 1704 in FIG. 17). Subsequently, after receiving a trigger operation (e.g., click operation) on the ninth control (e.g., the control 1705 corresponding to the string “View group purchase items from associated contacts” in FIG. 17) in the general settings page, the second client jumps from the general settings page to the resource display page (e.g., the page 1706 in FIG. 17) and displays the first prompt content (e.g., the string “You will no longer receive group purchase item recommendations from @First Store” shown in area 1707 of FIG. 17) on the resource display page. This ensures that the user of the second client will no longer see any recommendation information aggregation cards published by the account corresponding to the recommendation information aggregation card.

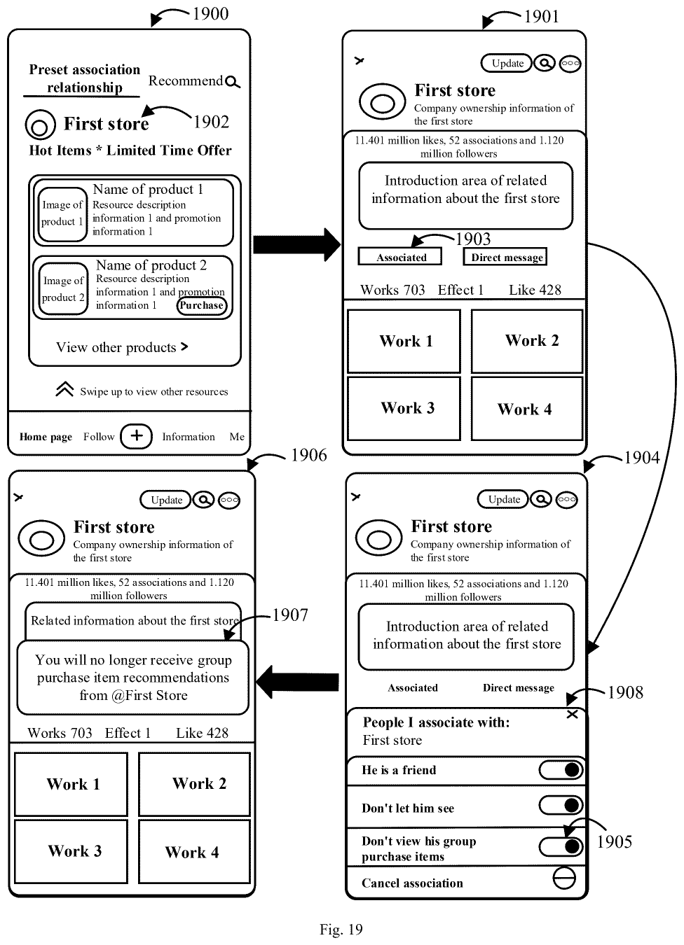

Method 5: for the above second client, when the second client is displaying the resource display page (e.g., the page 1900 in FIG. 19) corresponding to the above preset tag, after receiving a trigger operation (e.g., click operation) on user description information (e.g., the “first store” string shown in area 1902 of FIG. 19) in the resource display page, the second client jumps to the first detail page (e.g., the merchant detail page 1901 shown in FIG. 19), so that after the second client receives a trigger operation (e.g., click operation) on the eleventh control (e.g., the control 1903 in FIG. 19) in the first detail page, the third dropdown page (e.g., the page 1908 in FIG. 19) is displayed on the first detail page (e.g., the merchant detail page 1904 in FIG. 19). Then, after receiving a trigger operation (e.g., click operation) on the twelfth control (e.g., the control 1905 corresponding to the string “Do not view his group purchase items” in FIG. 19) in the third dropdown page, the second client closes the third dropdown page and displays the first prompt content (e.g., the string “You will no longer receive group purchase item recommendations from @First Store” shown in area 1907 of FIG. 19) on the first detail page (e.g., the merchant detail page 1906 in FIG. 19). This ensures that the user of the second client will no longer see any recommendation information aggregation cards published by the account corresponding to the recommendation information aggregation card.

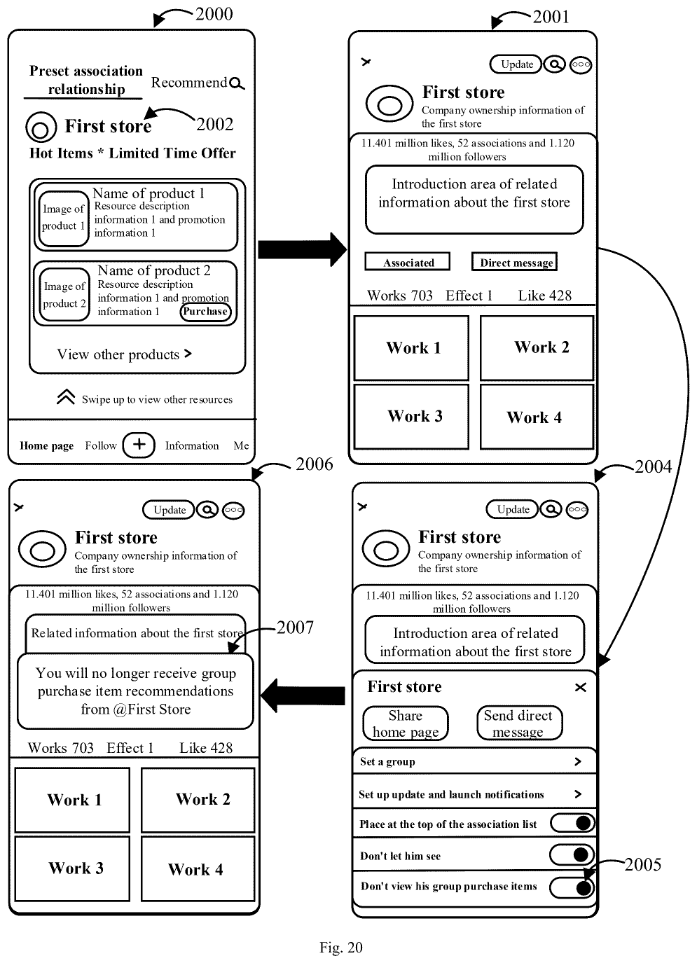

Method 6: for the above second client, when the second client is displaying the resource display page (e.g., the page 2000 in FIG. 20) corresponding to the above preset tag, after receiving a trigger operation (e.g., click operation) on user description information (e.g., the “first store” string shown in area 2002 of FIG. 20) in the resource display page, the second client jumps to the first detail page (e.g., the merchant detail page 2001 shown in FIG. 20), so that after the second client receives a trigger operation (e.g., click operation) on the thirteenth control (e.g., the control 2003 in FIG. 20) in the first detail page, the fourth dropdown page (e.g., the page 2008 in FIG. 20) is displayed on the first detail page (e.g., the merchant detail page 2004 in FIG. 20). Then, after receiving a trigger operation (e.g., click operation) on the fourteenth control (e.g., the control 2005 corresponding to the string “Do not view his group purchase items” in FIG. 20) in the fourth dropdown page, the second client closes the fourth dropdown page and displays the first prompt content (e.g., the string “You will no longer receive group purchase item recommendations from @First Store” shown in area 2007 of FIG. 20) on the first detail page (e.g., merchant detail page 2006 in FIG. 20). This ensures that the user of the second client will no longer see any recommendation information aggregation cards published by the account corresponding to the recommendation information aggregation card.

Example 3: in some cases, when the resource display page corresponding to the preset tag is displaying a certain recommendation information aggregation card (e.g., the interface 500 shown in FIG. 5), the viewer of the recommendation information aggregation card may want to share the recommendation information aggregation card with other users, so to meet the user's need, the viewer may use some interactive operations on the recommendation information aggregation card to implement the user's need. To facilitate understanding, a possible implementation method is provided below.

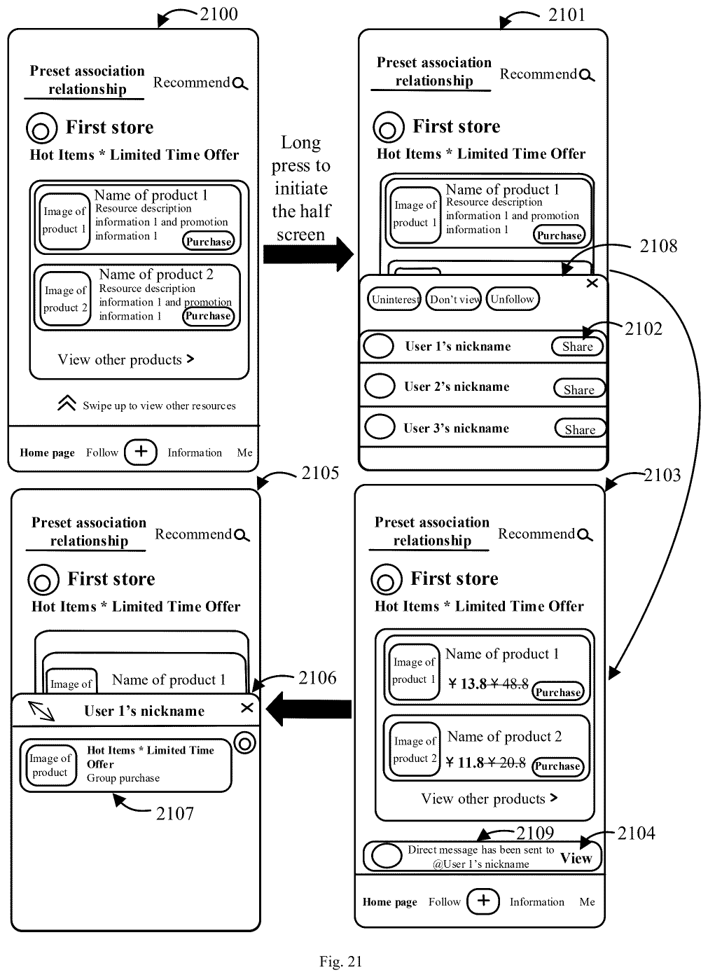

In one possible implementation method, for the above second client, when the second client is displaying the resource display page (e.g., the page 2100 in FIG. 21) corresponding to the above preset tag, after the second client receives the third operation (e.g., the “long press” operation shown in FIG. 21) on the resource display page, the second dropdown page (e.g., the page 2108 in FIG. 21) is displayed on the resource display page (e.g., the page 2101 in FIG. 21). Then, after receiving a trigger operation (e.g., click operation) on the fifteenth control (e.g., the control 2102 in FIG. 21) in the second dropdown page, the second client closes the second dropdown page and displays the second prompt content (e.g., the string “Direct message has been sent to @User 1's nickname” shown in the area 2109 of FIG. 21) on the resource display page (e.g., the page 2103 in FIG. 21). Subsequently, after the second client receives a trigger operation (e.g., click operation) on the sixteenth control, the fifth dropdown page (e.g., the page 2106 in FIG. 21) is displayed on the resource display page (e.g., the page 2105 in FIG. 21), so that sharing information (e.g., sharing information shown in the area 2107 of FIG. 21) is displayed in the fifth dropdown page. It should be noted that for the area 2107 in FIG. 21, product pictures shown in the area 2107 are randomly selected from multiple product pictures within the recommendation information aggregation card shown on the resource display page (e.g., the page 2105 in FIG. 21).

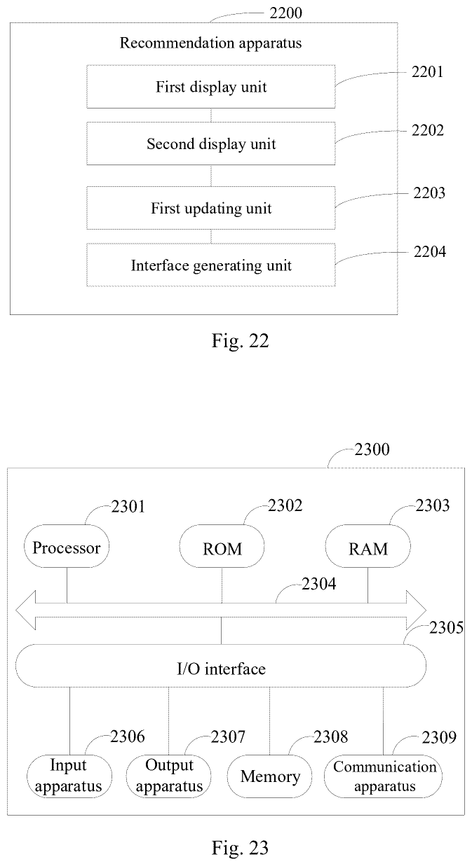

Based on the recommendation method applied to the first client provided by the embodiment of the present disclosure, an embodiment of the present disclosure also provides a recommendation apparatus, which will be explained and illustrated with reference to FIG. 22. FIG. 22 is a structural schematic diagram of a recommendation apparatus provided by an embodiment of the present disclosure. It should be noted that for the technical details of the recommendation apparatus provided by the embodiment of the present disclosure, please refer to the relevant content of the above recommendation method.

As shown in FIG. 22, the recommendation apparatus 2200 provided by an embodiment of the present disclosure includes a first display unit 2201, a second display unit 2202, a first updating unit 2203 and an interface generating unit 2204.

The first display unit 2201 is configured to, in response to a first operation, display an information configuration page.

The second display unit 2202 is configured to, in response to a trigger operation on a first control in the information configuration page, display an object aggregation page, in which the object aggregation page includes recommendation description information of at least one candidate object corresponding to a target account.

The first updating unit 2203 is configured to, in response to a selection operation on recommendation description information of at least one target object in the at least one candidate object, update the information configuration page by using the recommendation description information of the at least one target object.

The interface generating unit 2204 is configured to, in response to a trigger operation on a second control in the information configuration page, generate an object recommendation interface corresponding to the information configuration page, in which the object recommendation interface is used for displaying the recommendation description information of the at least one target object.

In a possible implementation mode, the information configuration page includes an information configuration area and a preview area; and the first updating unit 2203 is specifically configured to add the recommendation description information of the at least one target object in the information configuration area, and update an interface to be used that is displayed in the preview area by using the recommendation description information of the at least one target object.

In a possible implementation mode, the recommendation apparatus 2200 further includes a third display unit. The third display unit is configured to display an information management page, in which the information management page includes interface description information of at least one first recommendation interface corresponding to the target account. The first display unit 2201 is specifically configured to, in response to a trigger operation on a third control in the information management page, switch from the information management page to the information configuration page. The interface generating unit 2204 is specifically configured to, in response to the trigger operation on the second control in the information configuration page, generate the object recommendation interface corresponding to the information configuration page, switch from the information configuration page to the information management page, and update the information management page by using interface description information of the object recommendation interface, in which the updated information management page includes the interface description information of the object recommendation interface and the interface description information of the at least one first recommendation interface.

In a possible implementation mode, the updated information management page further includes a first candidate control corresponding to the object recommendation interface; and the recommendation apparatus 2200 further includes a first processing unit, which is configured to: when the first candidate control corresponding to the object recommendation interface is in a first display state, in response to a trigger operation on the first candidate control, adjust state description information in the interface description information of the object recommendation interface to first state description information, and/or, send an interface display end request corresponding to the object recommendation interface to a second client, in which a preset association relationship exists between an account corresponding to the second client and the target account, and the interface display end request is used for requesting to end a recommendation-display process for the object recommendation interface.

In a possible implementation mode, the recommendation apparatus 2200 further includes a second processing unit, which is configured to: when a publishing duration of the object recommendation interface is determined to meet a duration threshold corresponding to the object recommendation interface, adjust the state description information in the interface description information of the object recommendation interface to the first state description information, and/or, send the interface display end request corresponding to the object recommendation interface to the second client.

In a possible implementation mode, the updated information management page further includes a second candidate control corresponding to the object recommendation interface; and the recommendation apparatus 2200 further includes a first switching unit, which is configured to: when the second candidate control corresponding to the object recommendation interface is in a second display state, in response to a trigger operation on the second candidate control, switch from the information management page to an information configuration page corresponding to the object recommendation interface.

In a possible implementation mode, the updated information management page further includes a third candidate control corresponding to the object recommendation interface; and the recommendation apparatus 2200 further includes a fourth display unit, which is configured to: in response to a trigger operation on the third candidate control, display an interface description page corresponding to the object recommendation interface on the information management page, in which the interface description page is used for displaying the object recommendation interface and the interface description information of the object recommendation interface.

In a possible implementation mode, the recommendation apparatus 2200 further includes a second switching unit, which is configured to: after the displaying an interface description page corresponding to the object recommendation interface on the information management page, when a fourth control in the interface description page is in a third display state, in response to a trigger operation on the fourth control, jump to an information configuration page corresponding to the object recommendation interface.

In a possible implementation mode, when state description information in the interface description information of the object recommendation interface is second state description information, the interface description page is further used for displaying prompt information corresponding to the second state description information.

In a possible implementation mode, the recommendation apparatus 2200 further includes an information filtering unit, which is configured to: when the information management page is displayed and the information management page includes at least one second recommendation interface, in response to a condition input operation triggered on an information filtering condition input area in the information management page, display interface description information of a target recommendation interface in the at least one second recommendation interface on the information management page, in which the interface description information of the target recommendation interface meets an information filtering condition corresponding to the condition input operation, the at least one second recommendation interface includes the at least one first recommendation interface, or the at least one second recommendation interface includes the at least one first recommendation interface and the object recommendation interface.

In a possible implementation mode, the recommendation apparatus 2200 further includes a third switching unit, which is configured to: when the information management page is displayed and the information management page includes at least one second recommendation interface, in response to an account switching operation triggered on an account input area in the information management page, on the information management page, switch from interface description information of the at least one second recommendation interface corresponding to the target account to interface description information of at least one third recommendation interface corresponding to an account to be used, in which the account switching operation is used for switching from the target account to the account to be used in the account input area, the at least one second recommendation interface includes the at least one first recommendation interface, or the at least one second recommendation interface includes the at least one first recommendation interface and the object recommendation interface.

In a possible implementation mode, the recommendation apparatus 2200 further includes a fifth display unit and a second updating unit. The fifth display unit is configured to display a template configuration page in response to a trigger operation on a fifth control in the information configuration page. The second updating unit is configured to: in response to a template updating operation on the template configuration page, update the information configuration page by using a recommendation interface template corresponding to the template updating operation, in which the updated information configuration page is used for displaying at least one information configuration item in the recommendation interface template.

Based on the related content of the above recommendation apparatus 2200, it can be known that for the recommendation apparatus 2200 provided by an embodiment of the present disclosure, after the recommendation apparatus 2200 receives a first operation, the recommendation apparatus 2200 displays an information configuration page, so that a user of the recommendation apparatus 2200 can use the information configuration page to configure some recommendation information aggregation cards that meet the user's personalized needs (e.g., a product aggregation card that focuses on recommending multiple products with promotional activities, etc.). So after the recommendation apparatus 2200 receives a trigger operation on a first control (e.g., a control for selecting at least one product, etc.) in the information configuration page, the recommendation apparatus 2200 displays an object aggregation page, and the object aggregation page is used for displaying recommendation description information of at least one candidate object corresponding to a target account, so that after the recommendation apparatus 2200 receives a selection operation on the recommendation description information of at least one target object among these candidate objects, the recommendation apparatus 2200 updates the information configuration page by using the recommendation description information of these target objects, which allows the information configuration page to include the recommendation description information of the target objects. Finally, after the recommendation apparatus 2200 receives a trigger operation on a second control (e.g., submission control) in the information configuration page, the recommendation apparatus 2200 generates an object recommendation interface corresponding to the information configuration page, and the object recommendation interface is used for displaying the recommendation description information of these target objects, so that when the object recommendation interface is shown to a user, the user can view the recommendation description information of these target objects from the object recommendation interface, which can better meet the personalized product recommendation requirements of some merchants, thereby helping to improve the product recommendation experience of these merchants.

In addition, for the above information configuration page, the user of the recommendation apparatus 2200 only needs to execute some simple operations on the information configuration page, such as character input operation (e.g., inputting title content, etc.) and information selection operation (e.g., selecting the recommendation description information of some objects, etc.), without the need for executing other complicated operations (e.g., video data production, etc.). This can effectively simplify the production process of the above object recommendation interface, thereby helping to improve the user's interface production experience.

In addition, an embodiment of the present disclosure further provides an electronic device. The device includes a processor and a memory. The memory is configured to store instructions or computer programs; and the processor is configured to execute the instructions or computer programs in the memory to cause the electronic device to execute any implementation mode of the recommendation method provided by the embodiments of the present disclosure.

Referring to FIG. 23, which illustrates a structural schematic diagram of an electronic device 2300 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 23 is merely an example, and should not pose any limitation to the functions and the range of use of the embodiments of the present disclosure.

As shown in FIG. 23, the electronic device 2300 may include a processor 501 (e.g., a central processing unit, a graphics processing unit, etc.), which can perform various suitable actions and processing according to a program stored in a read-only memory (ROM) 2302 or a program loaded from a memory 2308 into a random-access memory (RAM) 2303. The RAM 2303 further stores various programs and data required for operations of the electronic device 2300. The processor 2301, the ROM 2302, and the RAM 2303 are interconnected by means of a bus 2304. An input/output (I/O) interface 2305 is also connected to the bus 2304.

Usually, the following apparatus may be connected to the I/O interface 2305: an input apparatus 2306 including, for example, a touch screen, a touch pad, a keyboard, a mouse, a camera, a microphone, an accelerometer, a gyroscope, or the like; an output apparatus 2307 including, for example, a liquid crystal display (LCD), a loudspeaker, a vibrator, or the like; a memory 2308 including, for example, a magnetic tape, a hard disk, or the like; and a communication apparatus 2309. The communication apparatus 2309 may allow the electronic device 2300 to be in wireless or wired communication with other devices to exchange data. While FIG. 23 illustrates the electronic device 2300 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 2309 and installed, or may be installed from the memory 2308, or may be installed from the ROM 2302. When the computer program is executed by the processor 2301, the above-mentioned functions defined in the methods of some embodiments of the present disclosure are performed.

The electronic device provided by an embodiment of the present disclosure belongs to the same invention idea as the method provided by the above embodiments, and the technical details not described in detail in the present embodiment can be referred to the above embodiments, and the present embodiment has the same beneficial effect as the above embodiments.

An embodiment of the present disclosure also provides a computer-readable medium. The computer-readable medium stores instructions or computer programs, and when the instructions or computer programs are run on a device, the device is caused to execute any implementation mode of the recommended method provided by the embodiments of the present disclosure.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a background image; display an initial picture of a target visual effect at a preset position of the background image; control the target visual effect to gradually change from the initial picture to a target picture in response to a visual effect change instruction triggered by a user; and adjust a filter effect of the background image to allow the filter effect of the background image to gradually change from a first filter effect to a second filter effect during a change of the target visual effect.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that embodiments in the present specification are described in a progressive manner, and each embodiment focuses on the differences from other embodiments, and the same and similar parts between each embodiment can refer to each other. For the system or device disclosed by the embodiments, because it corresponds to the method disclosed by the embodiments, the description is relatively simple, and the relevant points can be described in the method part.

It should be understood that in the present disclosure, “at least one(item)” means one or more, and “a plurality of” means two or more than two. “and/or” is used to describe the association relationship between associated objects, and denote that there are 3 relationships. For example, “A and/or B” can denote that only A, only B and both A and B exist, where A and B can be singular or plural. The character “/” generally indicates that the relationship between the preceding and posting objects is a relationship “or”. “At least one of the following” or other similar expressions thereof means any combination of these terms, including any combination of single or plural terms. For example, at least one of a, b or c, can denote: a, b, c, “a and b”, “a and c”, “b and c”, or “a and b and c”, where a, b and c can be single or multiple.

It should also be noted that in this article, relational terms such as first and second, etc., are used solely to distinguish one entity or operation from another, and do not necessarily require or imply any such actual relationship or sequence between those entities or operations. Further, the term “including”, “comprising” or any other variation thereof is intended to cover non-exclusive inclusion so that a process, process, article or apparatus that includes a series of elements includes not only those elements, but also other elements that are not expressly listed, or that are inherent to such process, method, article or apparatus. In the absence of further restrictions, the elements defined by the statement “including a . . . .” do not preclude the existence of other identical elements in the process, method, article or apparatus that includes the elements.

The steps of the method or algorithm described in the embodiments disclosed herein can be implemented directly with hardware, software modules executed by processors, or a combination of both. The software module can be placed in random access memory (RAM), memory, read-only memory (ROM), electrically programmable ROM, electrically erasable programmable ROM, registers, hard disks, removable disks, CD-ROMs, or any other form of storage medium known in the technical field.

The foregoing description of the disclosed embodiment enables a person skilled in the art to realize or use the present disclosure. The various modifications to these embodiments will be obvious to those skilled in the art, and the general principles defined herein can be realized in other embodiments without departing from the spirit or scope of the present disclosure. Therefore, the present disclosure will not be limited to these embodiments shown herein, but will conform to the widest range consistent with the principles and novelty features disclosed herein.

1. A recommendation method, applied to a first client, comprising:
in response to a first operation, displaying an information configuration page;
in response to a trigger operation on a first control in the information configuration page, displaying an object aggregation page, wherein the object aggregation page comprises recommendation description information of at least one candidate object corresponding to a target account;
in response to a selection operation on recommendation description information of at least one target object in the at least one candidate object, updating the information configuration page by using the recommendation description information of the at least one target object; and
in response to a trigger operation on a second control in the information configuration page, generating an object recommendation interface corresponding to the information configuration page, wherein the object recommendation interface is used for displaying the recommendation description information of the at least one target object.

2. The method according to claim 1, wherein the information configuration page comprises an information configuration area and a preview area; and
the updating the information configuration page by using the recommendation description information of the at least one target object, comprises:
adding the recommendation description information of the at least one target object in the information configuration area, and updating an interface to be used that is displayed in the preview area by using the recommendation description information of the at least one target object.

3. The method according to claim 1, wherein before the in response to a first operation, displaying an information configuration page, the method further comprises:
displaying an information management page, wherein the information management page comprises interface description information of at least one first recommendation interface corresponding to the target account;
the in response to a first operation, displaying an information configuration page, comprises:
in response to a trigger operation on a third control in the information management page, switching from the information management page to the information configuration page; and
the in response to a trigger operation on a second control in the information configuration page, generating an object recommendation interface corresponding to the information configuration page, comprises:
in response to the trigger operation on the second control in the information configuration page, generating the object recommendation interface corresponding to the information configuration page, switching from the information configuration page to the information management page, and updating the information management page by using interface description information of the object recommendation interface, wherein the updated information management page comprises the interface description information of the object recommendation interface and the interface description information of the at least one first recommendation interface.

4. The method according to claim 3, wherein the updated information management page further comprises a first candidate control corresponding to the object recommendation interface; and
the method further comprises:
when the first candidate control corresponding to the object recommendation interface is in a first display state, in response to a trigger operation on the first candidate control, adjusting state description information in the interface description information of the object recommendation interface to first state description information, and/or, sending an interface display end request corresponding to the object recommendation interface to a second client, wherein a preset association relationship exists between an account corresponding to the second client and the target account, and the interface display end request is used for requesting to end a recommendation-display process for the object recommendation interface;
or
the method further comprises:
when that a publishing duration of the object recommendation interface is determined to meet a duration threshold corresponding to the object recommendation interface, adjusting the state description information in the interface description information of the object recommendation interface to the first state description information, and/or, sending the interface display end request corresponding to the object recommendation interface to the second client.

5. The method according to claim 3, wherein the updated information management page further comprises a second candidate control corresponding to the object recommendation interface; and
the method further comprises:
when the second candidate control corresponding to the object recommendation interface is in a second display state, in response to a trigger operation on the second candidate control, switching from the information management page to an information configuration page corresponding to the object recommendation interface.

6. The method according to claim 3, wherein the updated information management page further comprises a third candidate control corresponding to the object recommendation interface; and
the method further comprises:
in response to a trigger operation on the third candidate control, displaying an interface description page corresponding to the object recommendation interface on the information management page, wherein the interface description page is used for displaying the object recommendation interface and the interface description information of the object recommendation interface.

7. The method according to claim 6, wherein after the displaying an interface description page corresponding to the object recommendation interface on the information management page, the method further comprises:
when a fourth control in the interface description page is in a third display state, in response to a trigger operation on the fourth control, jumping to an information configuration page corresponding to the object recommendation interface.

8. The method according to claim 6, wherein when state description information in the interface description information of the object recommendation interface is second state description information, the interface description page is further used for displaying prompt information corresponding to the second state description information.

9. The method according to claim 3, further comprising:
when the information management page is displaying and the information management page comprises at least one second recommendation interface, in response to a condition input operation triggered on an information filtering condition input area in the information management page, displaying interface description information of a target recommendation interface in the at least one second recommendation interface on the information management page, wherein the interface description information of the target recommendation interface meets an information filtering condition corresponding to the condition input operation, the at least one second recommendation interface comprises the at least one first recommendation interface, or the at least one second recommendation interface comprises the at least one first recommendation interface and the object recommendation interface.

10. The method according to claim 3, further comprising:
when the information management page is displaying and the information management page comprises at least one second recommendation interface, in response to an account switching operation triggered on an account input area in the information management page, on the information management page, switching from interface description information of the at least one second recommendation interface corresponding to the target account to interface description information of at least one third recommendation interface corresponding to an account to be used, wherein the account switching operation is used for switching from the target account to the account to be used in the account input area, the at least one second recommendation interface comprises the at least one first recommendation interface, or the at least one second recommendation interface comprises the at least one first recommendation interface and the object recommendation interface.

11. The method according to claim 1, wherein after the displaying an information configuration page, the method further comprises:
in response to a trigger operation on a fifth control in the information configuration page, displaying a template configuration page; and
in response to a template updating operation on the template configuration page, updating the information configuration page by using a recommendation interface template corresponding to the template updating operation, wherein the updated information configuration page is used for displaying at least one information configuration item in the recommendation interface template.

12. (canceled)

13. An electronic device, comprising at least one processor and at least one memory,
wherein the at least one memory is configured to store instructions or computer programs; and
the at least one processor is configured to execute the instructions or computer programs in the at least one memory to cause the electronic device to execute a recommendation method, the method is applied to a first client and comprises:
in response to a first operation, displaying an information configuration page;
in response to a trigger operation on a first control in the information configuration page. displaying an object aggregation page, wherein the object aggregation page comprises recommendation description information of at least one candidate object corresponding to a target account;
in response to a selection operation on recommendation description information of at least one target object in the at least one candidate object, updating the information configuration page by using the recommendation description information of the at least one target object; and
in response to a trigger operation on a second control in the information configuration page, generating an object recommendation interface corresponding to the information configuration page, wherein the object recommendation interface is used for displaying the recommendation description information of the at least one target object.

14. A non-transitory computer-readable medium, wherein the non-transitory computer-readable medium stores instructions or computer programs, and when the instructions or computer programs are run on a device, the device is caused to execute a recommendation method, the method is applied to a first client and comprises:
in response to a first operation, displaying an information configuration page;
in response to a trigger operation on a first control in the information configuration page, displaying an object aggregation page, wherein the object aggregation page comprises recommendation description information of at least one candidate object corresponding to a target account;
in response to a selection operation on recommendation description information of at least one target object in the at least one candidate object, updating the information configuration page by using the recommendation description information of the at least one target object; and
in response to a trigger operation on a second control in the information configuration page, generating an object recommendation interface corresponding to the information configuration page, wherein the object recommendation interface is used for displaying the recommendation description information of the at least one target object.

15. (canceled)

16. The electronic device according to claim 13, wherein the information configuration page comprises an information configuration area and a preview area; and
the updating the information configuration page by using the recommendation description information of the at least one target object, comprises:
adding the recommendation description information of the at least one target object in the information configuration area, and updating an interface to be used that is displayed in the preview area by using the recommendation description information of the at least one target object.

17. The electronic device according to claim 13, wherein before the in response to a first operation, displaying an information configuration page, the method further comprises:
displaying an information management page, wherein the information management page comprises interface description information of at least one first recommendation interface corresponding to the target account;
the in response to a first operation, displaying an information configuration page, comprises:
in response to a trigger operation on a third control in the information management page, switching from the information management page to the information configuration page; and
the in response to a trigger operation on a second control in the information configuration page, generating an object recommendation interface corresponding to the information configuration page, comprises:
in response to the trigger operation on the second control in the information configuration page, generating the object recommendation interface corresponding to the information configuration page, switching from the information configuration page to the information management page, and updating the information management page by using interface description information of the object recommendation interface, wherein the updated information management page comprises the interface description information of the object recommendation interface and the interface description information of the at least one first recommendation interface.

18. The electronic device according to claim 17, wherein the updated information management page further comprises a first candidate control corresponding to the object recommendation interface; and
the method further comprises:
when the first candidate control corresponding to the object recommendation interface is in a first display state, in response to a trigger operation on the first candidate control, adjusting state description information in the interface description information of the object recommendation interface to first state description information, and/or, sending an interface display end request corresponding to the object recommendation interface to a second client, wherein a preset association relationship exists between an account corresponding to the second client and the target account, and the interface display end request is used for requesting to end a recommendation-display process for the object recommendation interface;
or
the method further comprises:
when that a publishing duration of the object recommendation interface is determined to meet a duration threshold corresponding to the object recommendation interface, adjusting the state description information in the interface description information of the object recommendation interface to the first state description information, and/or, sending the interface display end request corresponding to the object recommendation interface to the second client.

19. The electronic device according to claim 17, wherein the updated information management page further comprises a second candidate control corresponding to the object recommendation interface; and
the method further comprises:
when the second candidate control corresponding to the object recommendation interface is in a second display state, in response to a trigger operation on the second candidate control, switching from the information management page to an information configuration page corresponding to the object recommendation interface.

20. The electronic device according to claim 17, wherein the updated information management page further comprises a third candidate control corresponding to the object recommendation interface; and
the method further comprises:
in response to a trigger operation on the third candidate control, displaying an interface description page corresponding to the object recommendation interface on the information management page, wherein the interface description page is used for displaying the object recommendation interface and the interface description information of the object recommendation interface.

21. The electronic device according to claim 17, wherein the method further comprises:
when the information management page is displaying and the information management page comprises at least one second recommendation interface, in response to a condition input operation triggered on an information filtering condition input area in the information management page, displaying interface description information of a target recommendation interface in the at least one second recommendation interface on the information management page, wherein the interface description information of the target recommendation interface meets an information filtering condition corresponding to the condition input operation, the at least one second recommendation interface comprises the at least one first recommendation interface, or the at least one second recommendation interface comprises the at least one first recommendation interface and the object recommendation interface.

22. The electronic device according to claim 17, wherein the method further comprises:
when the information management page is displaying and the information management page comprises at least one second recommendation interface, in response to an account switching operation triggered on an account input area in the information management page, on the information management page, switching from interface description information of the at least one second recommendation interface corresponding to the target account to interface description information of at least one third recommendation interface corresponding to an account to be used, wherein the account switching operation is used for switching from the target account to the account to be used in the account input area, the at least one second recommendation interface comprises the at least one first recommendation interface, or the at least one second recommendation interface comprises the at least one first recommendation interface and the object recommendation interface.
